(19) United States
(12) Patent Application Publication
(10) Pub. No.: US 2010/0142418 A1
(43) Pub. Date: Jun. 10, 2010

(54) DATA COMMUNICATION SYSTEM, DATA COMMUNICATION REQUEST DEVICE, AND DATA COMMUNICATION RESPONSE DEVICE

(76) Inventors: Shinichiro Nishioka, Osaka (JP); Keisuke Sakai, Kyoto (JP); Masayuki Toyama, Osaka (JP); Tsutomu Sekibe, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/665,079

(22) PCT Filed: May 13, 2009
(86) PCT No.: PCT/JP2009/002082

§ 371 Date: Jan. 28, 2010

(30) Foreign Application Priority Data
Jun. 2, 2008 (JP) 2008-144459

(51) Int. Cl. H04B 1/44

(52) U.S. Cl. 370/282

(57) ABSTRACT

The object of the present invention is to provide a data communication system in which a communication scheme is switched without a decrease in communication efficiency.

In a data communication system including first and second devices that are capable of performing full-duplex communication and half-duplex communication via a set of channels connecting the first and second devices, the first device transmits, via the set of channels, to the second device a first communication flag indicating whether half-duplex communication is to be specified in accordance with a communication processing capability of the first device, the second device transmits, via the set of channels, to the first device a second communication flag indicating whether half-duplex communication is to be specified in accordance with a communication processing capability of the second device, and the first and second devices select either a full-duplex communication scheme or a half-duplex communication scheme depending on the first and second communication flags in compliance with a procedure predetermined between the devices and perform data communication in the selected communication scheme, the selected communication scheme conforming to the communication processing capability of each device.

### TECHNICAL FIELD

The present invention relates to an art for selecting a communication method in a data communication system including a plurality of communication devices that are connected via a set of channels capable of full-duplex communication and half-duplex communication.

### BACKGROUND ART

Along with recent miniaturization and development of high speed processing technologies of semiconductor devices, a data amount that is communicated among apparatuses, or among LSIs mounted on an apparatus, is becoming all the more larger, whereas there still exist rigid restrictions on the number of LSI terminals (pads) which influences LSI package cost.

The communication modes used under such restrictions include a half-duplex communication scheme and a full-duplex communication scheme. In general, although the full-duplex communication scheme, which is easy to control, allows for communication at a higher speed, it has the following drawback. That is, while either a send function or a receive function operates in the full-duplex communication scheme, there is waste of the communication bandwidth that is allocated for the other function that is inactive. Accordingly, there has been disclosed an art for switching, while either transmitting or receiving is performed, the direction of a set of channels in full-duplex communication to establish the half-duplex communication scheme using the whole set of channels for one direction, so as to use the limited communication bandwidth effectively (Patent Literature 1).

According to Patent Literature 1, between two communication devices that are connected via a two-wire channel capable of full-duplex communication, when detecting transmit requests from both the devices simultaneously, the communication devices continue to perform data communication in the full-duplex scheme, and when detecting a transmit request only from one of the devices, they perform data communication after switching the full-duplex scheme to the half-duplex communication scheme.

According to the invention of Patent Literature 1, when, for example, the transmit request is output in one way from one communication device to the other communication device, the two channels may be controlled so that the communication takes place in one direction from the one communication device to the other communication device on the two channels, performing a half-duplex data communication.

### CITATION LIST

### Patent Literature

Patent Literature 1: Japanese patent application publication No. 2002-94600

### SUMMARY OF INVENTION

### Technical Problem

However, since the communication scheme is only determined depending on whether the transmit requests from both of the communication devices are detected simultaneously in the art disclosed in Patent Literature 1, the art does not always allow an effective communication.

For example, when data is transmitted by half-duplex communication from the communication device whose transmit processing capability is less than or equal to the transmission capability corresponding to the bandwidth of one of the channels, the device occupies, for the purpose of transmission, the two channels exceeding its transmit processing capability. As a result, the underflow of transmit buffer occurs and transmission and reception is caused to be halt, thereby leading to decrease in communication efficiency.

Similarly, when data is received by half-duplex communication from the communication device whose receive processing capability is less than or equal to the reception capability corresponding to the bandwidth of one of the channels, the device occupies, for the purpose of reception, the two channels exceeding its receive processing capability. As a result, the overflow of receive buffer occurs and some of the received data is caused to be lost. Due to the data loss, a retransmission procedure is required, thereby leading to a significant decrease in communication efficiency.

Thus, an object of the present invention is to provide a data communication system, a data communication require device, a data communication response device, a communication method, a data communication request method, and a data communication response method, all of which make it possible to switch a communication scheme without decreasing communication efficiency.

### Solution to Problem

In order to achieve the above object, one aspect of the present invention is a data communication system including first and second devices that are capable of performing full-duplex communication and half-duplex communication via a set of channels connecting the first and second devices, wherein full-duplex communication is established at initialization, the first device includes (i) a communication request unit operable to generate a request signal containing a first communication flag and transmit the generated request signal to the second device via the set of channels, the first communication flag indicating whether half-duplex communication is to be specified in accordance with a capability of the first device, (ii) a first selection unit operable to receive, from the second device, a response signal containing a second communication flag in response to the request signal and select either the full-duplex communication scheme or the half-duplex communication scheme depending on the first communication flag and the second communication flag, the second communication flag indicating whether half-duplex communication is to be specified in accordance with a capability of the second device, and the selected communication scheme conforming to the capability of each device, and (iii) a first communication unit operable to perform data communication in the selected communication scheme, and the second device includes (i) a communication response unit operable to generate the response signal containing the second communication flag in response to the received request signal and transmit the generated response signal to the first device via the set of channels, (ii) a second selection unit operable to select either the full-duplex communication scheme or the half-duplex communication scheme depending on the first communication flag and the second communication flag, the selected communication scheme conforming to the capability of each device, and (iii) a second communication unit operable to perform data communication in the selected communication scheme.

### ADVANTAGEOUS EFFECTS OF INVENTION

According to the above structure, since each of the first and second devices in the data communication system uses the first communication flag, the second communication flag, and the procedure predetermined between the devices, the both devices are able to select the identical communication scheme. Further, since data communication between the both devices cannot be commenced without handshaking between the request signal and the response signal that determines the communication scheme, the present invention makes it possible to determine the communication scheme conforming to the capability of each of the devices, without an additional procedure required for determination of the communication scheme. As a result, the occurrence of the underflow of transmit buffer and the overflow of receive buffer as mentioned in the problem description is suppressed in the data communication system, and therefore data communication is performed without a decrease in communication efficiency.

Here, prior to generating the request signal, the communication request unit may generate a priority flag in accordance with the capability of each device, store the generated priority flag in a predetermined first storage area, and transmit it to the second device, the priority flag indicating either the first device is to take priority or the second device is to take priority in accordance with the capability of each device, upon reception of the priority flag, the communication response unit may store the received priority flag in a predetermined second storage area, and the procedure may include the steps of judging whether an indication of the first communication flag accords with an indication of the second communication flag, and when judging affirmatively, selecting a communication scheme in accordance with the indication, and when judging negatively, causing the first and second selection units to select a communication scheme indicated by the communication flag generated by one of the devices which is to take priority, depending on the priority flags stored in the first and second storage areas respectively.

According to the above structure, since the first and second devices share the priority flag and select the communication scheme according to the indication, it is prevented that the devices select different communication schemes from each other when the indication of the first communication flag differs from the indication of the second communication flag.

Here, the capability may include a buffer capacity used for data reception, the request signal may include a communication type indicating either that the first device requests to transmit data or that the first device requests to receive data, the communication request unit may judge whether each device has a buffer capacity sufficient enough to secure an amount of data that is to be transmitted in a half-duplex communication bandwidth, and when judging affirmatively, generate a priority flag indicating that a data transmitting device is to take priority, and when judging negatively, generate a priority flag indicating a data receiving device is to take priority, the first and second selection unit may select, when the priority flag indicates that the data transmitting device is to take priority, a communication scheme indicated by a communication flag generated by the data transmitting device depending on the communication type, and select, when the priority flag indicates that the data receiving device is to take priority, a communication scheme indicated by a communication flag generated by the data receiving device depending on the communication type.

According to the above structure, when the indication of the first communication flag differs from the indication of the second communication flag, the first and second devices select the communication scheme in accordance with the indication of the communication flag transmitted from either a data transmitting device or a data receiving device, with use of the priority flag determined by the receive buffer capacity in each of the devices. Accordingly, the present invention makes it possible, in the data communication system, to prevent the overflow of the buffer in the receiving device when the priority flag indicates the receiving device, and to make the most use of the send capability of a sending device when the priority flag indicates the sending device.

Here, the communication request unit may receive information with respect to the capability of the second device, compare the capability indicated by the received information with the capability of the first device, and generate a priority flag indicating that one of the devices having the capability inferior to the other is to take priority according to a comparison result of the initialization unit, and the first and second selection units may select, when the priority flag indicates that the first device is to take priority, a communication scheme indicated by the first communication flag, and select, when the priority flag indicates that the second device is to take priority, a communication scheme indicated by the second communication flag.

According to the above structure, when the indication of the first communication flag differs from the indication of the second communication flag, the first and second devices select the communication scheme that is specified by one of the devices having the capability inferior to the other, with use of the priority flag. This allows the first and second devices in the data communication system to select the communication scheme specified by the device with inferior capability even when the indication of the first communication flag differs from that of the second communication flag, thereby perform processing within the range of the capability of each of the devices in a reliable manner.

Here, prior to generating the request signal, the communication request unit may receive information with respect to the capability of the second device, store the priority flag in a predetermined first storage area, and transmit it to the second device, the priority flag indicating that (i) full-duplex communication is to take priority, when the capability of at least one of the devices is not sufficient enough to perform half-duplex communication, and (ii) half-duplex communication is to take priority, when the capability of each device is sufficient enough to perform half-duplex communication, upon reception of the priority flag, the communication response unit may store the received priority flag in a predetermined second storage area, the procedure may include the steps of judging whether an indication of the first communication flag accords with an indication of the second communication flag, and when judging affirmatively, selecting a communication scheme in accordance with the indication, and when judging negatively, causing the first and second selection units to select a communication scheme which is to take priority, depending on the priority flags stored in the first and second storage areas respectively.

According to the above structure, the first and second devices select the communication scheme in accordance with the priority flag which is determined by the capability of each of the devices, even when the indication of the first communication flag differs from the indication of the second communication flag. Due to this, when one of the devices does not have a sufficient capability to perform half-duplex communication, full-duplex communication is selected by means of the priority flag. Accordingly, the both devices cannot perform data communication exceeding the capability of each of the devices.

Here, the first communication flag may indicate one of that (i) half-duplex communication is to be specified, (ii) full-duplex communication is to be specified, and (iii) either half-duplex communication or full-duplex communication is possible, when the first communication flag contained in the request signal indicates that either half-duplex communication or full-duplex communication is possible, the communication response unit may house the second communication flag in the response signal, the second communication flag indicating either that full-duplex communication is to be specified or that half-duplex communication is to be specified, and the procedure may include a step of selecting, when the first communication flag indicates that either half-duplex communication or full-duplex communication is possible, a communication scheme indicated by the second communication flag.

According to the above structure, when the first communication flag of the first device indicates that either full-duplex communication or half-duplex communication may be possible, the second communication flag specified by the second device is used, so as to perform data communication within the range of the capability of each of the devices.

Here, the first communication flag may indicate either that half-duplex communication is to be specified or that full-duplex communication is to be specified, the second communication flag may indicate one of that (i) half-duplex communication is to be specified, (ii) full-duplex communication is to be specified, and (iii) either half-duplex communication or full-duplex communication is possible, and the procedure may include a step of selecting, when the second communication flag indicates that either half-duplex communication or full-duplex communication is possible, a communication scheme indicated by the first communication flag.

According to the above structure, when the second communication flag of the second device indicates that either full-duplex communication or half-duplex communication may be possible, the first communication flag specified by the first device is used, so as to perform data communication within the range of the capability of each of the devices.

Here, the communication request unit may judge whether data that is to be communicated has a size equal to or greater than a predetermined size, and thereafter house, when the size of data is less than the predetermined size, a first communication flag indicating that a half-communication is not to be specified in the request signal, and house, when the size of data is equal to or greater than the predetermined size, a first communication flag in accordance with the capability of the first device in the request signal, and the communication response unit may judge whether data that is to be communicated has a size equal to or greater than a predetermined size, and thereafter house in the response signal, when the size of data is less than the predetermined size, a second communication flag indicating that half-duplex communication is not to be specified, and house, when the size of data is equal to or greater than the predetermined size, a second communication flag in accordance with the capability of the second device.

According to the above structure, when communicating data of a relatively small size, it is prevented that communication efficiency decreases due to overhead in terms of time that is required for switching the direction of the channels as a result of half-duplex communication being selected.

Further, another aspect of the present invention is a data communication request device that transmits a data communication request to an other device via a set of channels connecting the data communication request device and the other device, which are capable of performing full-duplex communication and half-duplex communication, comprising: a communication request unit operable to generate a request signal containing a first communication flag and transmit the generated request signal to the other device via the set of channels, the first communication flag indicating whether half-duplex communication is to be specified in accordance with a capability of the data communication request device; a selection unit operable to receive, from the other device, a response signal containing a second communication flag in response to the request signal, and select either a full-duplex communication scheme or a half-duplex communication scheme depending on the first communication flag and the second communication flag in compliance with the procedure, the second communication flag indicating whether half-duplex communication is to be specified in accordance with a capability of the other device, and the selected communication scheme conforming to the capability of each device; and a communication unit operable to perform data communication in the selected communication scheme.

According to the above structure, the data communication request device selects, according to the predetermined procedure, the communication scheme common to the own device and the other device, in accordance with the first communication flag and the second communication flag. Further, since the selected communication scheme conforms to the capability of each of the devices, each of the devices cannot perform processing exceeding the capability of their own. Accordingly, the data communication request device performs data communication without decreasing communication efficiency.

Here, prior to generating the request signal, the communication request unit may receive information with respect to the capability of the other device, compare the capability indicated by the received information with the capability of the data communication request device, store the priority flag in a predetermined storage area, and transmit it to the other device, the priority flag indicating one of the devices having the capability inferior to the other according to a comparison result of the initialization unit, the procedure may include the steps of judging whether an indication of the first communication flag accords with an indication of the second communication flag, and when judging affirmatively, selecting a communication scheme in accordance with the indication, and when judging negatively, causing the selection unit to select a communication scheme indicated by the communication flag generated by one of the devices which is to take priority depending on the priority flag stored in the predetermined storage area.

According to the above structure, since the data communication request device shares the priority flag with the other device so that the communication scheme can be selected with use of the priority flag, it is prevented that each of the devices selects a different communication scheme from each other when the indication of the first communication flag differs from the indication of the second communication flag.

Here, in the data communication, data transmission and reception may be performed for a plurality of times via the set of channels, each time data is transmitted and received, a request signal may be generated and transmitted, and in generating a request signal with respect to data transmission and reception for a second time or later on, the communication request unit may compare a current capability of the data communication request device with the capability of the other device, update the priority flag stored in the predetermined storage area according to a comparison result of the communication request unit, generate a request signal containing the updated priority flag, and transmit the generated request signal to the other device.

According to the above structure, since the data communication request device updates the priority flag during the data communication, it is possible to select the communication scheme conforming to the capability of each of the devices at the point of the data transmission and reception during the data communication.

Further, another aspect of the present invention is a data communication response device that receives a data communication request from an other device via a set of channels connecting the data communication response device and the other device, which are capable of performing full-duplex communication and half-duplex communication, comprising: a communication response unit operable to receive, from the other device, a request signal containing a first communication flag, generate a response flag containing a second communication flag, and transmit the generated response signal to the other device via the set of channels, the first communication flag indicating whether half-duplex communication is to be specified in accordance with a capability of the other device, the second communication flag indicating whether half-duplex communication is to be specified in accordance with a capability of the data communication response device; a selection unit operable to select either a full-duplex communication scheme or a half-duplex communication scheme depending on the first communication flag and the second communication flag in compliance with the procedure, the selected communication scheme conforming to the capability of each device; and a communication unit operable to perform data communication in the selected communication scheme.

According to the above structure, the data communication response device selects, according to the predetermined procedure, the identical communication scheme common to the own device and the other device, in accordance with the first communication flag and the second communication flag. Further, since the selected communication scheme conforms to the capability of each of the devices, each of the devices cannot perform processing exceeding the capability of their own. Accordingly, the data communication request device performs data communication without decreasing communication efficiency.

Here, prior to receiving the request signal, the communication response unit may receive a priority flag and store the received priority flag in a predetermined storage area, the priority flag indicating that a communication flag specified by one of the devices having the capability inferior to the other is to take priority, the procedure may include the steps of judging whether an indication of the first communication flag accords with an indication of the second communication flag, and when judging affirmatively, selecting a communication scheme in accordance with the indication, and when judging negatively, selecting a communication scheme indicated by the communication flag generated by one of the devices which is to take priority depending on the priority flag stored in the predetermined storage area.

According to the above structure, since the data communication response device shares the priority flag with the other device and selects the communication mode with use of the priority flag, it is prevented that each of the devices selects a different communication scheme from each other when the indication of the first communication flag differs from the indication of the second communication flag.

Here, in the data communication, data transmission and reception may be performed for a plurality of times via the set of channels, each time data is transmitted and received, a request signal may be transmitted from the other device, prior to commencement of the data communication, the communication response unit may receive information with respect to the capability of the other device and store the received information, and in generating a response signal in response to a request signal with respect to data transmission and reception for a second time or later on, the communication response unit may compare a current capability of the data communication response device with the capability of the other device, update the priority flag stored in the predetermined storage area according to a comparison result of the communication response unit, generate a response signal containing the updated priority flag, and transmit the generated response signal to the other device.

According to the above structure, since the data communication response device updates the priority flag during the data communication, it is possible to select the communication scheme conforming to the capability of each of the devices at the point of the data transmission and reception during the data communication.

Here, the set of channels may comprise two serial channels, the other device may include at least two terminals of first and second terminals used for data communication, the data communication response device may comprise a memory card or an I/O card that includes at least two terminals of third and fourth terminals used for data communication, the data communication response device may be removable from the other device, and when the data communication response device is attached to the other device, two serial channels may be formed in such a way that the first and third terminals are connected and that the second and fourth terminals are connected respectively.

According to the above structure, since the memory card or the I/O card can be used as the data communication response device, these cards allow for data communication without decreasing communication efficiency in communication with the other device.

### BRIEF DESCRIPTION OF DRAWINGS

FIG. 1 is a block diagram showing a structure of each of communication devices 20, 30 in a data communication system 10.

FIG. 2 shows a communication flow when sharing control information.

FIG. 3 shows example formats of a data structure of each of request signals 60.

FIG. 4 shows example formats of a data structure of each of response signals 70.

FIG. 5 shows various example formats of a priority flag 230 (330).

FIG. 6 shows a structure of a switch unit 204.

FIG. 7 shows a structure of a switch unit 304.

FIG. 8 shows a structure in the case a master 20 transmits data to a slave 30 by half-duplex communication.

FIG. 9 shows a structure in the case the master 20 receives data from the slave 30 by half-duplex communication.

FIG. 10 is a flowchart showing an outline of processing in the data communication system 10.

FIG. 11 is a flowchart showing processing of the master 20.

FIG. 12 is a flowchart showing communication request processing.

FIG. 13 is a flowchart showing communication scheme setting processing.

FIG. 14 is a flowchart showing communication scheme selection processing.

FIG. 15 is a flowchart showing processing of the slave 30.

FIG. 16 is a flowchart showing communication response processing.

FIG. 17 is a flowchart showing communication scheme switch operations.

FIG. 18 is a flowchart showing selection processing in the case a communication mode flag contains unselected state.

FIG. 19 is a flowchart showing processing of the master 20 in the case data that is to be transmitted and received is divided into a plurality of blocks.

FIG. 20 is a flowchart showing processing of the slave 30 in the case data that is to be transmitted and received is divided into a plurality of blocks.

FIG. 21 is a block diagram showing a structure of a communication device 20a in a communication system 10a.

FIG. 22 is a block diagram showing a structure of an SD card 30a in the data communication system 10a of FIG. 21.

### DESCRIPTION OF EMBODIMENT

### 1. First Embodiment

Description will be made below on a communication device of the present invention with reference to figures.

### <1. 1> Structure of Data Communication System 10

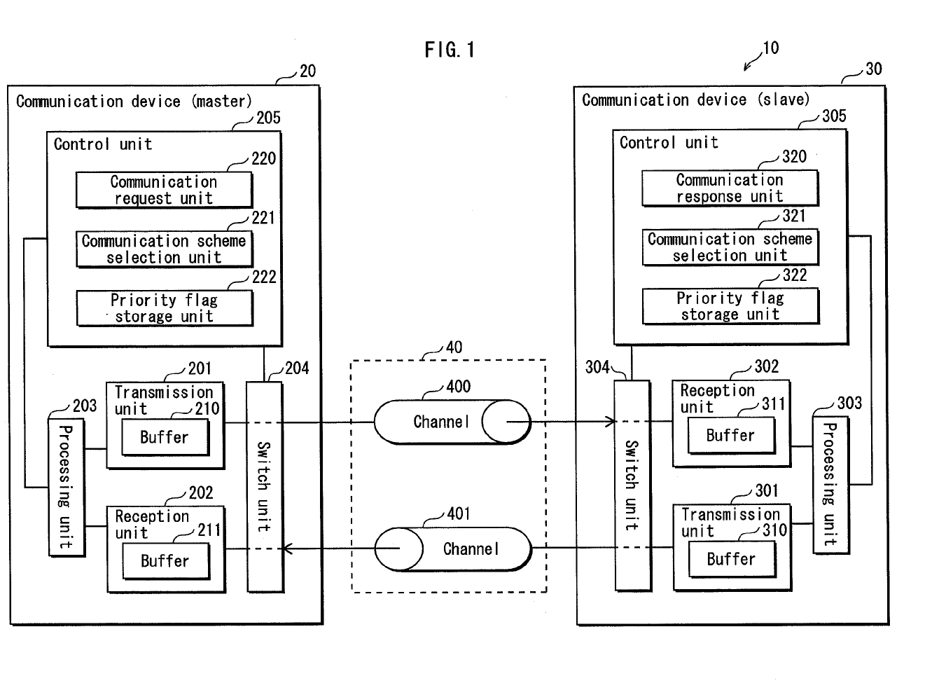

FIG. 1 shows a general structure of a data communication system 10 according to an embodiment of the present invention.

As shown in FIG. 1, the data communication system 10 comprises a communication device (master) 20, a communication device (slave) 30, and a set of channels 40.

The set of channels 40 comprises channels 400, 401, and realizes full-duplex communication and half-duplex communication between the master 20 and the slave 30.

The master 20 is a device that outputs a request signal as a trigger for commencement of communication. On the other hand, the slave 30 is a device that outputs, in response to the request signal, a response signal to the master 20 when it is ready for communication. In addition, in the present embodiment, the relation between the master 20 and the slave 30 remains static.

When performing data communication, the master 20 and the slave 30 each designate a communication scheme of either full-duplex communication or half-duplex communication that conforms to the capability (i.e. the communication processing capability) of the own device, and select an identical communication scheme from those designated by each of the devices. The data communication herein means data transmission and reception which ought to be targeted for actual processing of the master 20, that is, the data which ought to be written from the master 20 to the slave 30 or read from the slave 30 by the master 20.

The master 20 and the slave 30 perform data communication in the selected identical communication scheme.

Meanwhile, when performing data communication for a small amount of data between the master 20 and the slave 30 with use of handshaking, in order to transfer the request signal and the response signal simultaneously, communication in the full-duplex communication mode with the channel 400 as a downstream channel and the channel 401 as an upstream channel is carried out. The downstream herein means transmission of the data from the master 20 to the slave 30, while the upstream means transmission of the data from the slave 30 to the master 20.

In addition, in the data communication system 10 in the present embodiment, full-duplex communication is performed as a predetermined communication scheme (referred to below as a “predetermined scheme”).

### <1. 2> Structure of Master 20

As shown in FIG. 1, the master 20 comprises a transmission unit 201, a reception unit 202, a processing unit 203, a switch unit 204, and a control unit 205.

### (1) Transmission Unit 201 and Reception Unit 202

Each of the transmission unit 201 and the reception unit 202 includes a function similar to a DMA (Direct Memory Access) circuit, and also has buffers 210 or 211 that help to equilibrate the difference between the communication bandwidth on the channels 400, 401 connecting the devices and the data processing capability of the processing unit 203, as shown in FIG. 1.

### (2) Control Unit 205

The control unit 205 comprises a CPU and a memory and the like, and controls data communication while supervising the state of the data communication.

As shown in FIG. 1, the control unit 205 includes a communication request unit 220, a communication scheme selection unit 221, and a priority flag storage unit 222.

The control unit 205 executes processing with respect to data that is to be transmitted to the slave 30 and data that was received from the slave 30. The data processing herein means the processing in which the master 20 reads data from the slave 30 or the processing in which the master 20 writes data into the slave 30. The read processing includes the processing in which the master 20 stores to the own storage unit (not shown), such as an HDD, a read request to the slave 30 and a received data. The write processing also includes processing with respect to a write request to the slave 30.

The control unit 205 also executes processing with respect to initialization of communication, so that information with respect to communication (control information) may be shared by each of the devices.

### (2-1) Communication Request Unit 220

Now, description will be made on the communication request unit 220.

### (On Initialization of Communication)

Firstly, operations with respect to initialization of communication will be described. Here, the initialization of communication means the transmission and reception of data that is necessary for sharing the information with respect to communication.

The communication request unit 220 preliminarily stores control information of the own device. The control information herein includes information about the data address available for transmission and reception, the standard data block length that the own device may deal with, the buffer capacity of each of the transmission unit 201 and the reception unit 202, and communication scheme switching time or a data processing speed (data processing rate) in the own device. In the present embodiment, each of the above information is regarded as a piece of the control information, and each of the control information (about the data address space to which transmission and reception may be carried out, the standard data block length, the buffer capacity, the switching time, the processing speed) is stored as a control register mapped in an I/O address space.

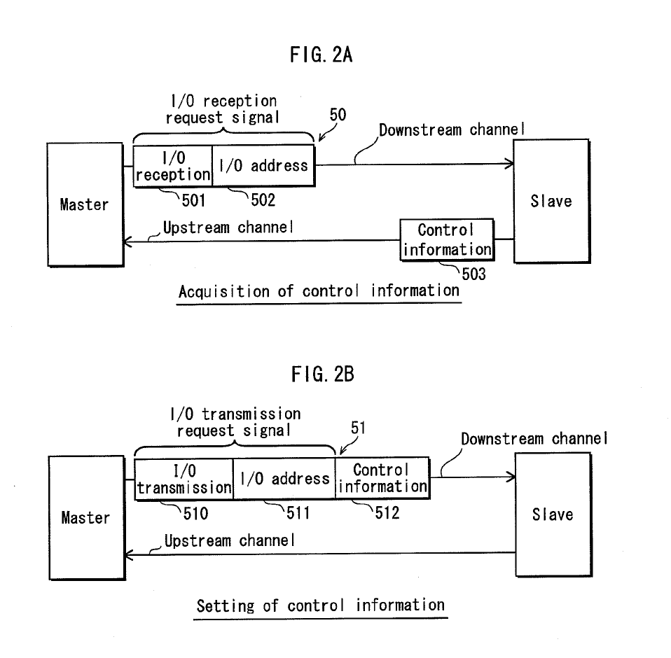

The communication request unit 220 generates an I/O receive request signal 50 that requests the control information owned by the slave 30, so as to share the control information required for communication with the slave 30. The generated I/O receive request signal 50 is converted to a data packet signal in a packet unit and the packet signal is transmitted to the slave 30. For example, the I/O receive request signal 50 is, as shown in FIG. 2A, a signal including an I/O reception 501 and an I/O address 502. The I/O reception 501 is an identifier that requests to read the control information owned by the slave 30, and the I/O address 502 serves to identify the control information (a control register) that is a target of the read request.

For each of the data that the communication request unit 220 requests to read, (such as, the data address space, the buffer capacity, the standard data block length, the switching time, and the processing speed), the communication request unit 220 generates an I/O receive request signal 50 and transmits the generated I/O receive request signals 50 to the slave 30 sequentially.

After transmitting each I/O receive request signal 50 sequentially, the communication request unit 220 receives, from the slave 30, the control information (such as, the data address space, the buffer capacity, the standard data block length, the switching time, and the processing speed) 503 owned by the slave 30 via the processing unit 203.

The communication request unit 220 compares the received control information 503 with the corresponding control information with respect to the own device, to determine control information that is to be used for data communication. For example, when receiving the information about the buffer capacity from the slave 30 as the control information, the communication request unit 220 compares the received information with the own buffer capacity, and then determines the smaller one as the control information that is to be used for data communication. When receiving the standard data block length, the communication request unit 220 also determines the smaller block length as the control information for data communication, and when receiving the switching time and processing time, it also determines the longer time as the control information for data communication. In other words, the communication request unit 220 determines the control information owned by one of the devices with inferior communication processing capability as the control information that is to be used for data communication.

The communication request unit 220 generates an I/O transmit request signal 51 containing the determined control information 512. The generated I/O transmit request signal 51 is converted to a data packet signal in a packet unit in the processing unit 203 and the packet signal is transmitted to the slave 30.

For example, the I/O transmit request signal 51 is, as shown in FIG. 2B, a signal including an I/O transmission 510 and an I/O address 511 with the determined control signal 512 attached at the end thereof. The I/O transmission 510 and the I/O address 511 are identical to those contained in the I/O receive request signal 50.

The communication request unit 220 also generates a priority flag in accordance with the communication processing capability of each of the devices. The priority flag herein is defined as follows. The priority flag is shared by each of the devices and used for selecting the communication scheme as needed, and the priority flag indicates either that the communication scheme specified by the master 20 is to take priority or that the communication scheme specified by the slave 30 is to take priority, for example.

The communication request unit 220 stores the generated priority flag in the priority flag storage unit 222, and also transmits it to the slave 30. This enables the both devices to share the priority flag.

When generating the priority flag, the communication request unit 220 determines the indication by making use of the information about the data processing time (data transferring rate) for comparison of the communication processing capabilities, so that the communication mode specified by the device whose processing time is longer than the other device may take priority.

The above operations of the communication request unit 220 enables the own device to share with the slave 30 the control information required in advance of the commencement of communication, thereby providing a ready-for-communication state.

### (During Data Communication)

After sharing the control information required for data communication in the above initialization of communication, the communication request unit 220 generates the request signal 60 in advance of transmission and reception of the data that is to be read or written. The generated request signal is converted to a packet signal in a packet unit and the packet signal is transmitted to the slave 30.

The request signal includes, for example, a communication type 601, a communication mode flag 602, an address 603, and a size 604. The communication type 601 indicates the type of the signal: a value “00” indicates an I/O transmit request signal, a value “01” indicates an I/O receive request signal, a value “10” indicates a data transmit request signal, and a value “11” indicates a data receive request signal respectively, for example. The communication mode flag identifies the communication mode which is to be used for data transmission and reception: a value “0” indicates full-duplex communication, and a value “1” indicates half-duplex communication respectively, for example. Note that the value “0” indicating full-duplex communication means that, when putting it the other way around, half-duplex communication may not be carried out.

The address 603 indicates, for each of data, a write starting position when the master 20 requests to write, and a read starting position when the master 20 requests to read.

The size 604 indicates a size of data that is to be written when the master 20 requests to write the data, and a size of data that is to be read when the master 20 requests to read.

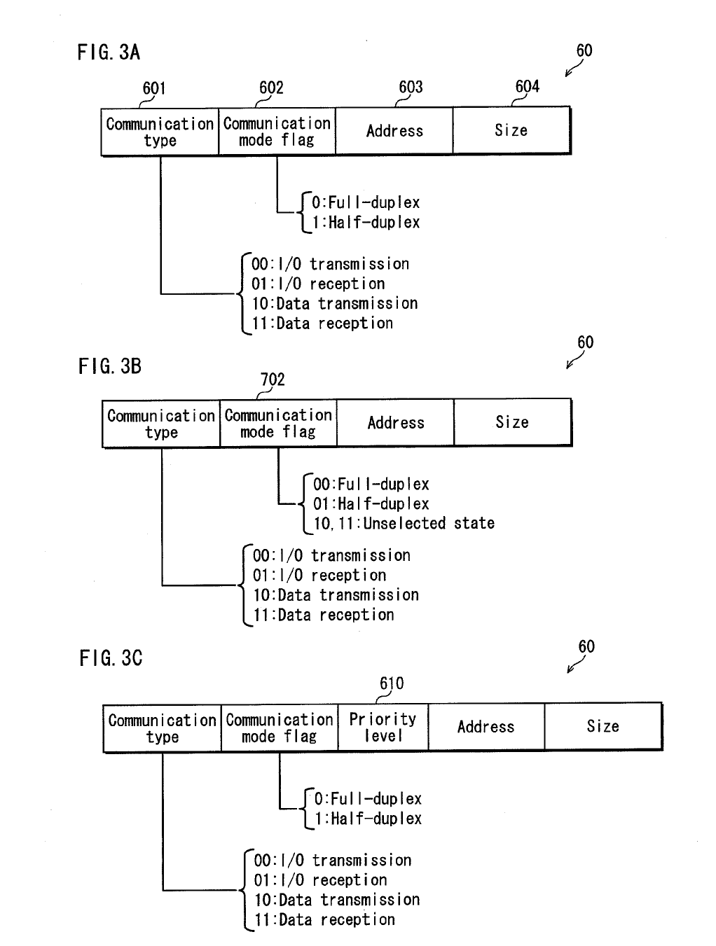

Meanwhile, the I/O receive request signal 50 and the I/O transmit request signal 51 shown in FIGS. 2A, 2B differ from the request signal 60 of FIG. 3A at least in the point that the communication mode flag 602 and the size 604 are omitted. This is because of the following reasons. Since, when the communication type 601 indicates the I/O receive request signal or the I/O transmit request signal, the content to be communicated is control information (a control register), whose size is generally fixed, the size 604 may be omitted. Further, since the control information has a size relatively small, taking into consideration the overhead associated with the communication mode switching, it is preferable to perform the I/O transmission and reception only in full-duplex communication. Accordingly, it is not necessary to switch the originally predetermined full-duplex communication and therefore to add the communication mode flag 602. Meanwhile, the I/O receive request signal 50 and the I/O transmit request signal 51 may be formed identically to the request signal 60 without omitting the communication mode flag 602 and the size 604.

When generating the request signal 60, the communication request unit 220 determines the communication scheme that is to be notified to the slave 30. For example, the communication request unit 220 determines whether the data to be transmitted or received has a size large enough to compensate for the overhead associated with switching of the direction of the channels 400, 401. In the present embodiment, if the data to be transmitted or received has an actual size adequate enough compared to a predetermined threshold value that has been set with respect to the overhead associated with switching of the direction of the channels 400, 401, the communication request unit 220 determines the communication mode in accordance with the transmission and reception capability. On the other hand, if the data does not have the adequate actual size as above, the communication request unit 220 determines that it specify full-duplex communication for the slave 30. This is to say, the communication request unit 220 sets full-duplex communication mode (the value “0”) in the communication mode flag 602.

Now, determination of the communication scheme in accordance with the transmission and reception capability will be explained.

The communication request unit 220 calculates a buffer size required for data transmission and reception, with use of Formula 1 shown below. When requesting to write data, the communication request unit 220 judges whether the calculated buffer size may be secured in the buffer 210, and if judging affirmatively, the communication request unit 220 sets the half-duplex communication mode (the value “1”) in the communication flag 602, and if judging negatively, the communication request unit 220 sets full-duplex communication mode (the value “0”) in the communication mode flag 602. Similarly, when requesting to read data, the communication request unit 220 judges whether the calculated buffer size may be secured in the buffer 211, and if judging affirmatively, the communication request unit 220 sets the half-duplex communication mode (the value “1”) in the communication flag 602, and if judging negatively, the communication request unit 220 sets full-duplex communication mode (the value “0”) in the communication mode flag 602.

$$( Buffer size ) = ( Data size ) \times \frac{\begin{matrix}( Communication band ) - \\ ( Data processing speed )\end{matrix}}{( Communication band )} \qquad [ Formula 1 ]$$

After transmitting the request signal 60, the communication request unit 220 subsequently receives, from the slave 30, a response signal 70 in response to the transmitted request signal via the processing unit 203.

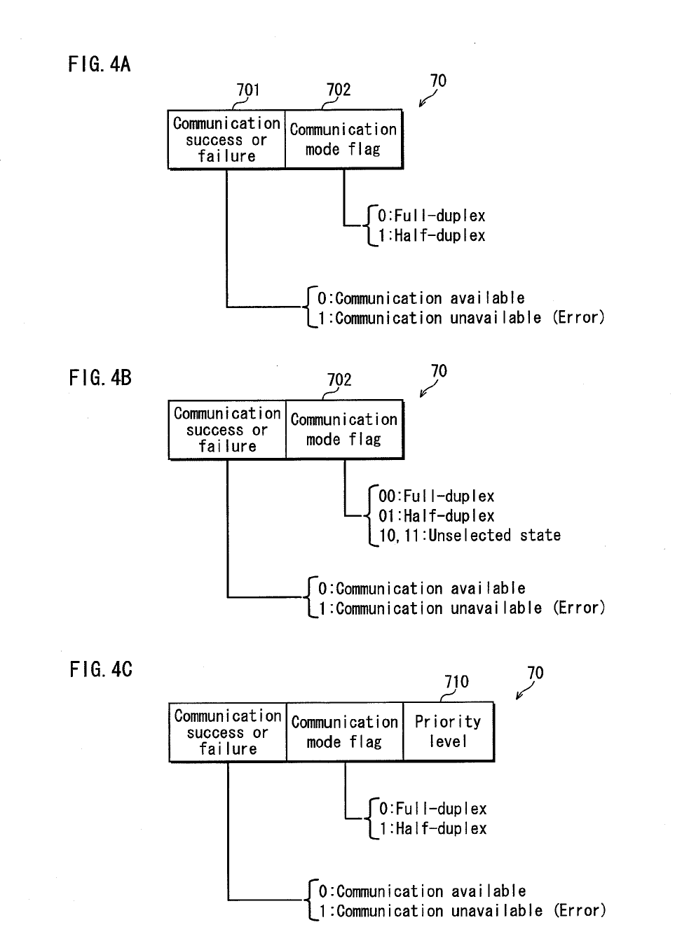

The response signal 70 includes, for example, communication success or failure 701, and a communication mode flag 702, as shown in FIG. 4A. The communication success or failure 701 contains information regarding whether the request signal 60 transmitted from the master 20 has been received, or it has not been received due to errors in the address 603 or the size 604 contained in the request signal 60. For example, a value “0” indicates that the request signal 60 has been received (i.e. communication is available), and a value “1” indicates that the request signal has not been received (i.e. communication is unavailable, that is, an error) respectively. The communication mode flag 702 identifies the communication mode determined (specified) by the slave 30, and has a composition similar to the communication mode flag 602.

### (2-2) Communication Mode Selection Unit 221

The communication mode selection unit 221 uniquely selects one of the full-duplex communication scheme and the half-duplex communication scheme from the communication flag 602 contained in the request signal 60 that was transmitted from the own device to the slave 30 and the communication flag 702 contained in the response signal 70 that was received from the slave 30 by the own device, and performs control with respect to switching of the switch unit 204 in accordance with the selection. Note that a selection method and the control with respect to switching will be described later.

The communication mode selection unit 221 also reestablishes the originally predetermined communication scheme once data communication by half-duplex communication comes to an end.

### (2-3) Priority Flag Storage Unit 222

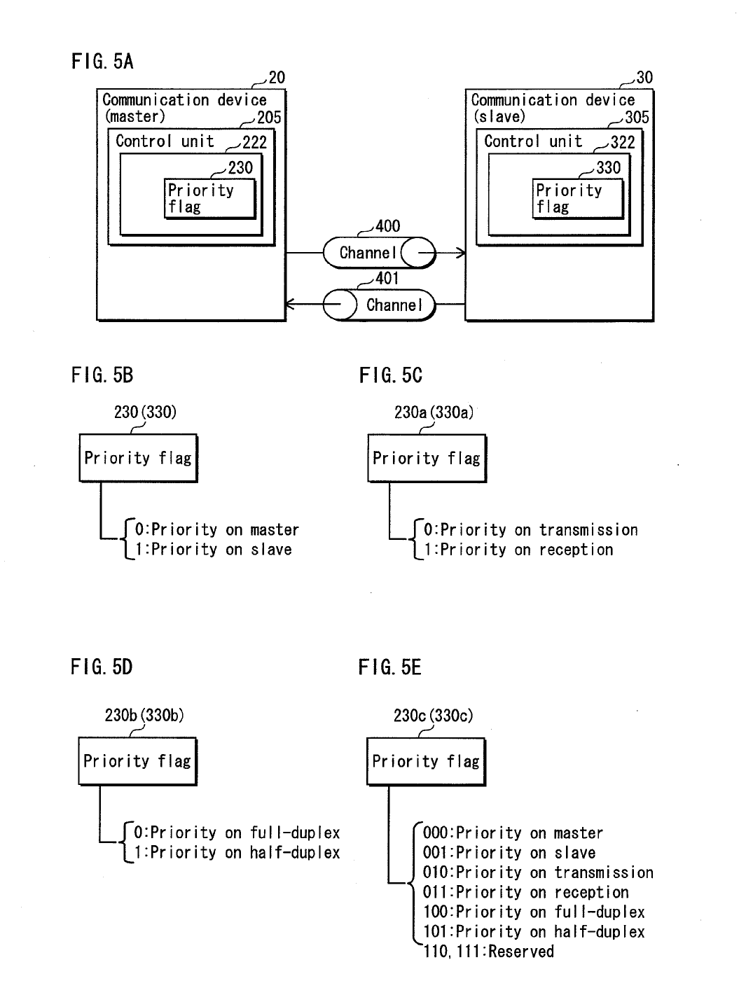

As shown in FIG. 5A, the priority flag storage unit 222 includes an area that stores the priority flag 230 whose indication is shared between the own device and the slave 30, the priority flag being stored in initialization of communication. The setting of the priority flag is performed in the communication request unit 220, as mentioned above.

Now, an example of the priority flag 230 will be looked at with reference to FIG. 5B. As can be seen, when the priority flag 230 indicates the value “0” it means that the master is to take priority (i.e. the communication mode specified by the communication mode flag contained in the request signal is to take priority), and when the priority flag 230 indicates the value “1” it means that the slave is to take priority (i.e. the communication mode specified by the communication mode flag contained in the response signal is to take priority).

Note that the above explanation also applies to the priority flag 330 owned by the slave 30, which will be described later.

### (3) Processing Unit 203

The processing unit 203 performs processing on the data which is to be transmitted to the slave 30 (i.e. written into the slave 30), generates a packet signal in a packet unit, and transmits the packet signal to the slave 30 via the transmission unit 201.

The processing unit 203 also converts the I/O receive request signal 50, the I/O transmit request signal 51, and the request signal 60 during data communication, all of which were received from the control unit 205, to packet signals in a packet unit to transmit each of the packet signals to the slave 30 via the transmission unit 201.

The processing unit 203 also performs processing on the received data that has been accumulated in the buffer 211, and sends each of the data to the control unit 205. For example, the processing unit 203 outputs the control information 503 and the response signal 70 to the control unit 205.

### (4) Switch Unit 204

The switch unit 204 switches the direction of the channels 400, 401, as well as the connection between the transmission unit 201 and the reception unit 202, depending on whether the communication scheme selected in the communication scheme selection unit 221 (i.e. the communication mode during data transmission and reception) is full-duplex communication or half-duplex communication.

Description will be made below on details of the switch unit 204.

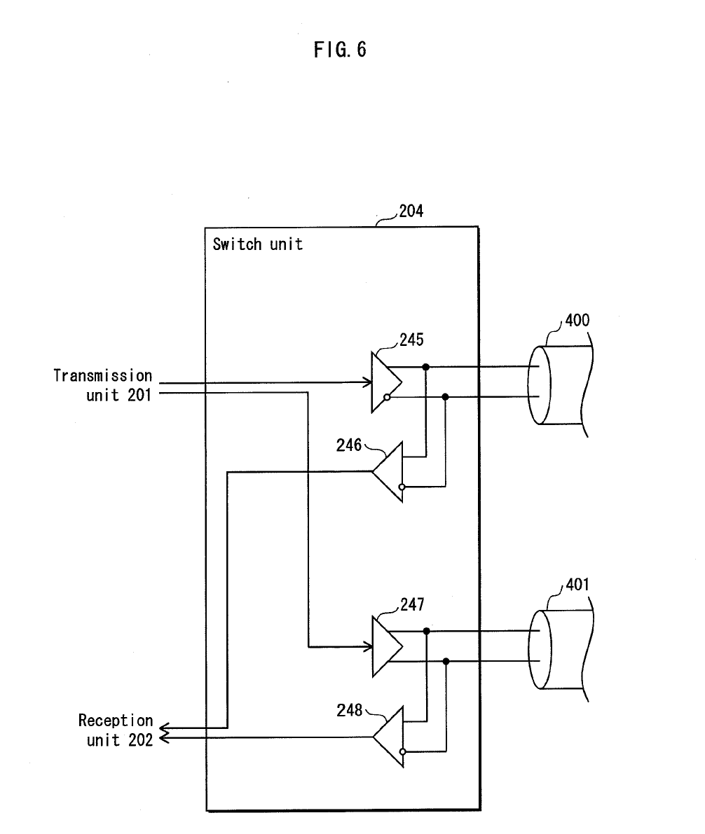

As shown in FIG. 6, the switch unit 204 includes differential transmitters 245, 247 and differential receivers 246, 248.

The differential transmitters 245, 247 and the differential receivers 246, 248 serve to transmit and receive serial data via the channels 400, 401. As mentioned above, the operations of the differential transmitters 245, 247 and the differential receivers 246, 248 are controlled by the control unit 205.

The above control with respect to the switching by the communication mode selection unit 221 herein means to switch the communication mode to either full-duplex communication or half-duplex communication, by selectively activating (i) one of the differential transmitters 245, 247 and one of the differential receivers 246, 248, or (ii) either the differential transmitters 245, 247 or the differential receivers 246, 248. For example, when the communication mode selection unit 221 selects full-duplex communication as the communication scheme, the communication mode selection unit 221 controls to activate the differential transmitter 245 and the differential receiver 248, so as to switch the communication scheme. On the other hand, when half-duplex communication is selected as the communication scheme, the communication mode is switched as follows: if the master 20 requests data reception, the communication mode selection unit 221 controls to activate the differential receivers 246, 248, and if the master 20 requests data transmission, the communication mode selection unit 221 controls to activate the differential transmitters 245, 247.

Meanwhile, although control of bit synchronization is normally supposed to take place after switching of the communication, description will be omitted here since it does not relate to the essence of the present invention.

### <1.3> Structure of Slave 30

As shown in FIG. 1, the slave 30 comprises a transmission unit 301, a reception unit 302, a processing unit 303, a switch unit 304, and a control unit 305.

### (1) Transmission Unit 301 and Reception Unit 302

As shown in FIG. 1, each of the transmission unit 301 and the reception unit 302 includes buffers 310 and 311 respectively, as similarly to the transmission unit 210 and the reception unit 202 included by the master 20.

### (2) Control Unit 305

The control unit 305 comprises a CPU, a memory, and the like, and controls communication while supervising the state of data communication, as similarly to the control unit 205 included by the master 20. As shown in FIG. 1, the control unit 305 includes a communication response unit 320, a communication mode selection unit 321, and a priority flag storage unit 322.

The control unit 305 executes processing with respect to data that is to be transmitted to the master 20 or that was received from the master 20. Since the data processing herein is similar to the data processing in the master 20, description will be omitted.

Just like the control unit 205 in the master 20, the control unit 305 performs processing with respect to initialization of communication necessary for each of the devices to share information with respect to communication (control information).

### (2-1) Communication Response Unit 320

Now description will be made on the communication response unit 320.

### (On Initialization of Communication)

Firstly, operations with respect to the initialization of communication will be described.

Just like the communication request unit 220 of the master 20, the communication response unit 320 preliminarily stores control information about the own device.

The communication response unit 320 receives an I/O reception request signal 50 from the master 20 via the reception unit 302 and the processing unit 303.

The communication response unit 320 transmits the control information 503 that was requested by the received I/O receive request signal 50. The control information 503 herein is converted to a data packet signal in a packet unit in the processing unit 303 and transmitted to the master 20.

Subsequently, the communication response unit 320 receives an I/O transmit request signal 51 containing control information 512 which is to be shared with the master 20, and stores the control information 512 contained in the received I/O transmit request signal 51 in a predetermined storing area.

Then, upon receiving a priority flag from the master 20, the communication response unit 32 stores the received priority flag in the priority flag storage unit 322.

The above operations of the communication response unit 320 enables the own device and the master 20 to share the control information required in advance of the commencement of communication, thereby providing the ready-for-communication state.

### (During Data Communication)

After sharing the control information required for data communication in the above initialization of communication, the communication response unit 320 receives a request signal 60 from the master 20 via the reception unit 302 and the processing unit 303, and then generates a response signal 70. At this time, the communication response unit 320 performs an error check on the received request signal 60, and if an error is detected, the communication response unit 320 sets a value “1” in the communication success or failure 701, and if an error is not detected, the communication response unit 320 sets a value “0” in the communication success or failure 701. The communication response unit 320 also determines the communication scheme that is to be notified to the master in a same manner as the determination method of the communication request unit 220.

The communication response unit 320 then transmits the generated response signal 70 to the master 20 via the processing unit 303 and the transmission unit 301 at a timing in which data transmission and reception may be commenced. The response signal 70 herein is converted to a data packet signal in a packet unit and transmitted to the master 20.

### (2-2) Communication Scheme Selection Unit 321

Since the communication scheme selection unit 321 is similar to the communication selection unit 221 of the master 20, description will be omitted here.

### (2-3) Priority Flag Storage Unit 322

As shown in FIG. 5A, the priority flag storage unit 322 includes an area that stores the priority flag 330 whose indication is shared between the own device and the master 20, and stores the priority flag 330 in initialization of communication. The setting of the priority flag is performed in the communication response unit 320, as mentioned above.

As shown in FIG. 5B, the priority flag 330 is identical to the priority flag 230.

### (3) Processing Unit 303

The processing unit 303 performs processing on the data which is to be transmitted to the master 20 (i.e. read by the master 20), generates a packet signal in a packet unit, and transmits the packet signal to the master 20 via the transmission unit 301.

The processing unit 303 also converts the control information 503 and the response signal 70 in data communication, both of which were received from the control unit 305, to packet signals in a packet unit, and transmits each of the packet signals to the master 20 via the transmission unit 301.

The processing unit 303 also performs processing on received data that has been accumulated in the buffer 311, and sends each of the data to the control unit 305. For example, the processing unit 303 outputs, to the control unit 305, the I/O transmit request signal 51 containing the control information 512 and the request signal 60.

### (4) Switch Unit 304

The switch unit 304 switches the direction of the channels 400, 401, as well as the connection between the transmission unit 301 and the reception unit 302, depending on whether the communication scheme selected in the communication scheme selection unit 321 (i.e. the communication mode during data transmission and reception) is full-duplex communication or half-duplex communication.

Description will be made below on details of the switch unit 304.

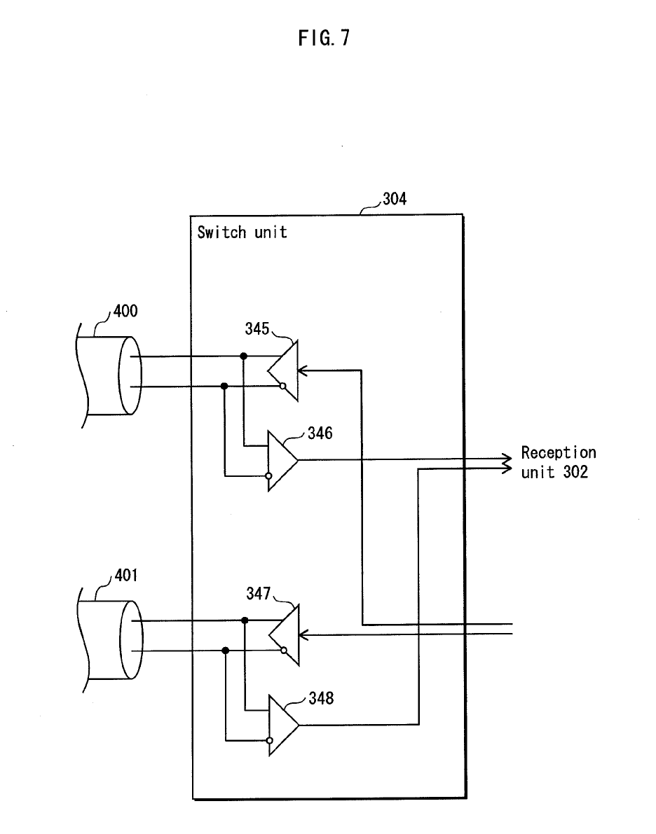

As shown in FIG. 7, the switch unit 304 includes differential transmitters 345, 347 and differential receivers 346, 348.

The differential transmitters 345, 347 and the differential receivers 346, 348 serve to transmit and receive serial data by means of the channels 400, 401. As mentioned above, operations of the differential transmitters 345, 347 and the differential receivers 346, 348 are controlled by the control unit 305.

Although the communication scheme selection unit 321 then performs control with respect to switching, description will be omitted here since the operations are identical to those performed by the communication scheme selection unit 221.

Meanwhile, although control of bit synchronization is normally supposed to take place after switching of the communication as similarly to the master 20, description will be omitted here since it does not relate to the essence of the present invention.

### <1.4> Switching of Communication Scheme

Now then, description will be made on switching of the communication scheme.

FIG. 1 shows a data communication system 10 whose communication scheme is full-duplex communication. In this case, in the switch unit 204 the differential transmitter 245 and the differential receiver 248 are controlled to be activated, and in the switch unit 304 the differential transmitter 347 and the differential receiver 346 are controlled to be activated. This allows for full-duplex communication with the channel 400 used for a downstream channel and the channel 401 used for an upstream channel.

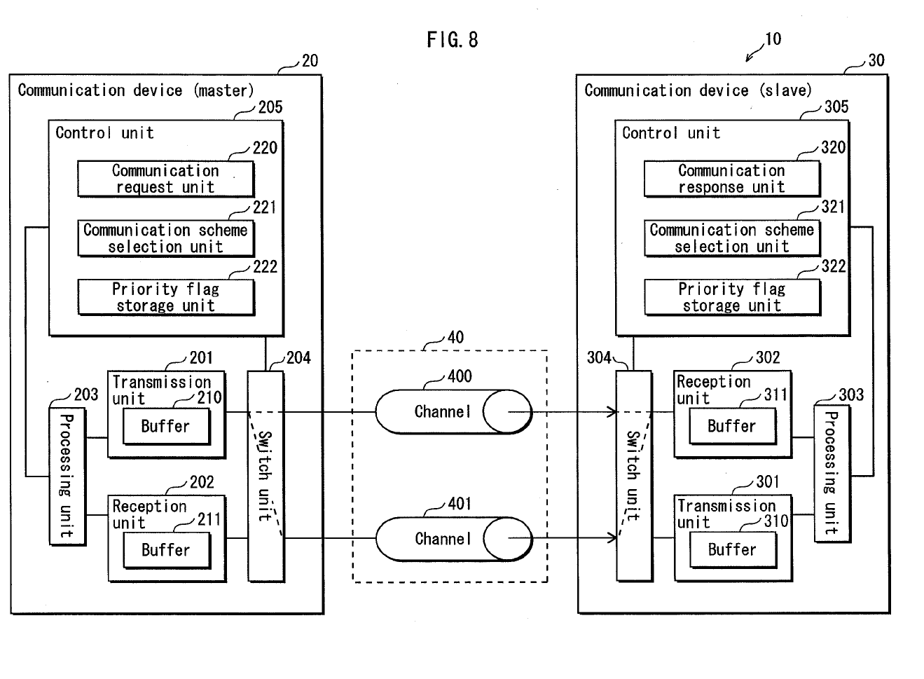

FIG. 8 shows a data communication system 10 whose communication scheme is half-duplex communication in which the master 20 transmits data to the slave 30. In this half-duplex transmission, each of the switch units 204, 304 switches the communication scheme from full-duplex communication to half-duplex communication, for transmission processing from the transmission unit 201 of the master 20 to the reception unit 302 of the slave 30 using the channels 400, 401. More specifically, in the switch unit 204 the differential transmitters 245, 247 are controlled to be activated, and in the switch unit 304 the differential receivers 346, 348 are controlled to be activated. This allows for half-duplex communication with both the channels 400, 401 used for downstream channels.

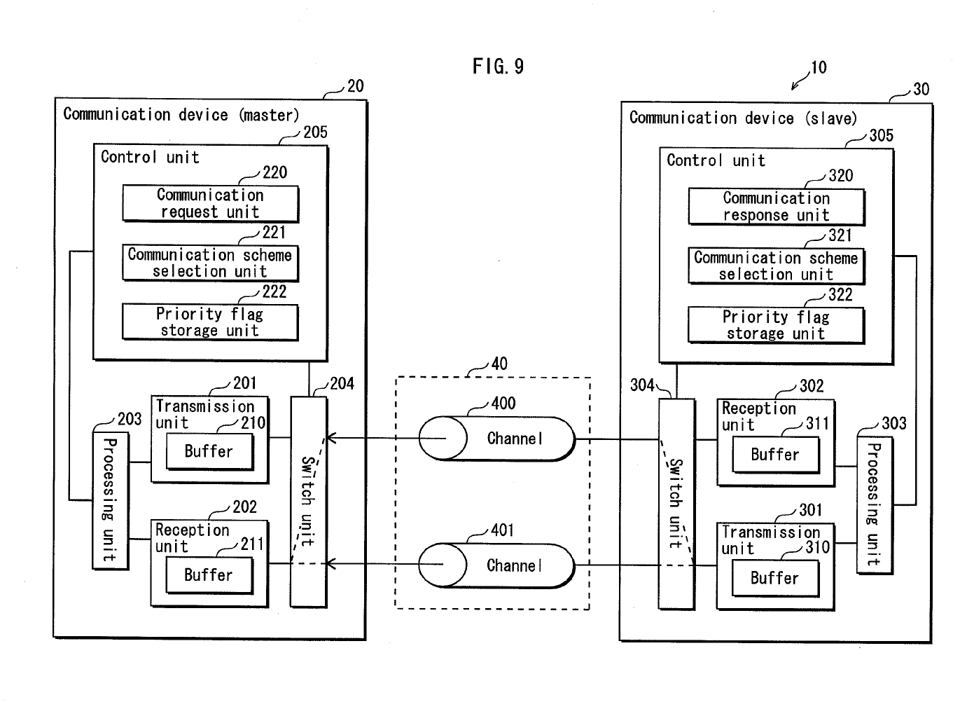

FIG. 9 shows a data communication system 10 whose communication scheme is half-duplex communication in which the master 20 receives data from the slave 30. In this half-duplex reception, each of the switch units 204, 304 switches the communication scheme from full-duplex communication to half-duplex communication, for reception processing from the transmission unit 301 of the slave 30 to the reception unit 202 of the master 20 using the channels 400, 401. More specifically, in the switch unit 204 the differential receivers 246, 248 are controlled to be activated, and in the switch unit 304 the differential transmitters 345, 347 are controlled to be activated. This allows for half-duplex communication with both the channels 400, 401 used for upstream channels.

### (1.5) Operations

### (1) Outline of Operations of Data Communication System 10

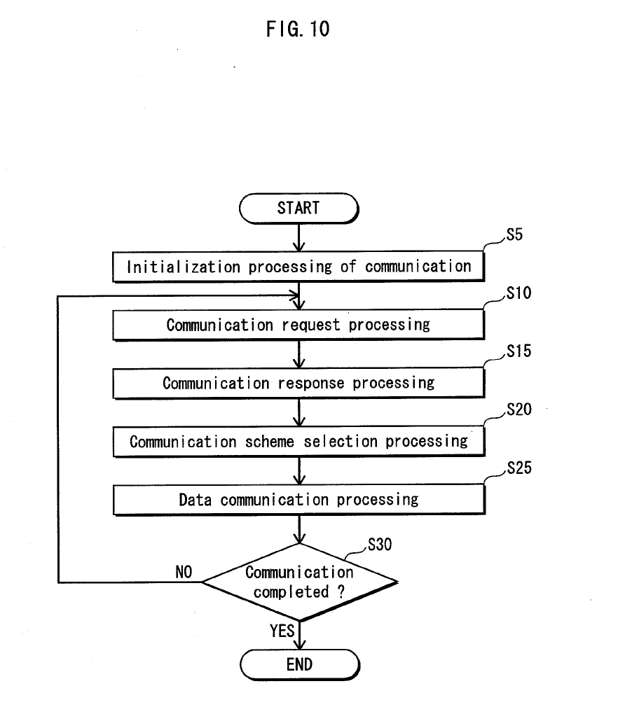

Now the outline of operations of data communication system 10 will be described, with reference to a flowchart of FIG. 10.

In the data communication system 10, the initialization processing of communication is performed in order that the master 20 and the slave 30 may transmit or receive the I/O receive request signal 50, the I/O transmit request signal 51, and the control information 503, 512, so as to share the control information used for data communication (Step S5). This processing enables the master 20 and the slave 30 to share the control information required in advance of the commencement of communication, thereby providing the ready-for-communication state.

In the data communication system 10, communication request processing is performed, in which the master 20 transmits to the slave 30 the request signal 60 including the communication mode flag 602 specified by the master 20 itself, and the slave 30 receives the request signal 60 (Step S10).

Subsequently, in the data communication system 10, communication response processing is performed, in which the slave 30 transmits to the master 20 the response signal 70 including the communication mode flag 702 specified by the slave 30 itself, and the master 20 receives the response signal 70 (Step S15).

Once handshaking between the master 20 and the slave 30 comes into being due to the communication request processing and the communication response processing, each of the master 20 and the slave 30 in the data communication system 10 selects the communication scheme which is to be used for data communication uniquely (Step S20), by using the communication mode flags 602, 702 specified by each of the master 20 and the slave 30.

In the data communication system 10, data communication processing of data transmission and reception is performed in the communication scheme in accordance with the communication mode selected uniquely in the communication mode selection processing (Step S25).

In the data communication system 10, then, it is judged whether the communication has been completed or not, that is to say, whether there still exists data which remains to be transmitted (Step S 30), and if judging the communication has been completed, the processing is terminated in the data communication system 10, and if judging the communication has not been completed, the processing of the data communication system 10 returns to Step S10 so that the data communication is continued to be performed.

### (2) Operations of Master 20

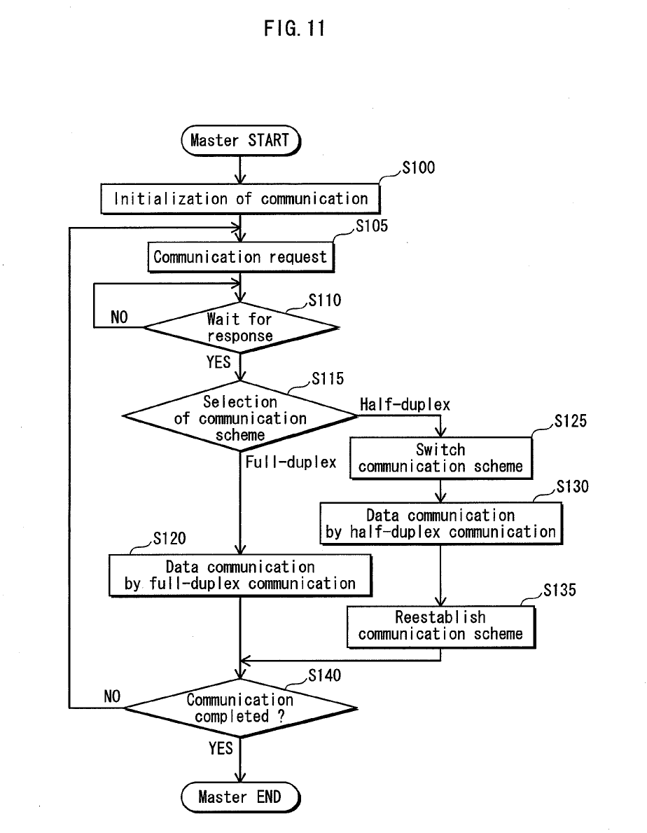

Now, the operations of the master 20 during data communication will be described, with reference to a flowchart of FIG. 11.

The master 20 executes processing on the master 20 side in the initialization processing of communication shown in FIG. 10 (Step S100). More specifically, the communication request unit 220 generates the I/O receive request signal 50, and transmits the generated I/O receive request signal 50 to the slave 30. Subsequently, upon receiving the control information 503 owned by the slave 30, the communication request unit 220 compares the control owned by the own device and the received control information to determine the control information required for data communication. The communication request unit 220 then generates the I/O transmit request signal containing the determined control information, and transmits the generated I/O transmit request signal to the slave 30. This enables the master 20 and the slave 30 to share the control information required for communication, thereby providing the ready-for-communication state.

The communication request unit 220 executes processing on the master 20 side in the communication request processing shown in FIG. 10 (Step S105). Here, the communication request unit 220 determines the communication scheme which is to be notified to be the slave 30, generates the request signal 60 containing the communication mode flag 602 which indicates the determined communication scheme, and transmits the generated request signal 60 to the slave 30. The operations will be described later in details.

The communication request unit 220 executes processing on the master 20 side in the communication response processing shown in FIG. 10 (Step S110). More specifically, after transmitting the request signal 60, the communication request unit 220 enters its reception waiting state until it receives the response signal 70 containing the communication mode flag 702 which indicates the communication scheme specified by the slave 30, and once the communication request unit 220 receives the response signal 70 (“YES” in Step S110), the communication request unit 220 moves on to a next step.

The communication scheme selection unit 221 executes the communication scheme selection processing shown in FIG. 10, and selects the communication scheme for data communication (Step S115).

When full-duplex communication is selected for the communication scheme (“full-duplex communication” in Step S115), the master 20 performs data communication by full-duplex communication as the data communication processing shown in FIG. 10 (Step S120).

When half-duplex communication is selected for the communication scheme (“half-duplex communication” in Step S115), the master 20 performs operations of Steps S125 to S135 as the data communication processing shown in FIG. 10. Here, the operations of Steps S125 to S135 correspond to the case in which half-duplex communication is performed in the data communication processing shown in FIG. 10.

The communication scheme selection unit 221 switches the communication scheme from the predetermined full-duplex communication scheme to the half-duplex communication scheme (Step S125). More specifically, when the master 20 requests data reception, the communication scheme selection unit 221 controls the differential receivers 246, 248 to be activated. On the other hand, when the master 20 requests data transmission, the communication scheme selection unit 221 controls the differential transmitters 245, 247 to be activated.

The control unit 205 performs data communication by the communication scheme brought about by the switching (Step S130).

Once data transmission or reception comes to an end, the communication scheme selection unit 221 switches the communication scheme to the predetermined communication scheme in order to reestablish the communication scheme (Step S135). More specifically, the communication scheme selection unit 221 controls the differential transmitters 245 and the differential receiver 248 to be activated.

The control unit 205 judges whether the communication is completed or not, that is to say, whether there still exists data which remains to be transmitted or received (Step S140).

If judging that the communication has been completed, that is to say, there exists no data to be transmitted or received (“YES” in Step S140), the control unit 205 terminates the processing. If judging that communication has not been completed, that is to say, there still exists data to be transmitted or received (“NO” in Step S140), the processing of the control unit 205 returns to Step S105. Here, the operations in S140 correspond to those on the master 20 side in the operations in Step S30 in FIG. 10.

Note that, when full-duplex communication is selected, data communication by full-duplex communication in the communication directions on the channels 400, 401, as shown in FIG. 1, is performed in the data communication system 10. On the other hand, when half-duplex communication is selected, (i) if data is transmitted from the master 20 to the slave 30, data communication by half-duplex communication in the communication direction on the channels 400, 401, as shown in FIG. 8, is performed in the data communication system 10, and (ii) if data is received from the slave 30 by the master 20, data communication by half-duplex communication in the communication direction on the channels 400, 401, as shown in FIG. 9, is performed in the data communication system 10.

### (3) Communication Response Processing

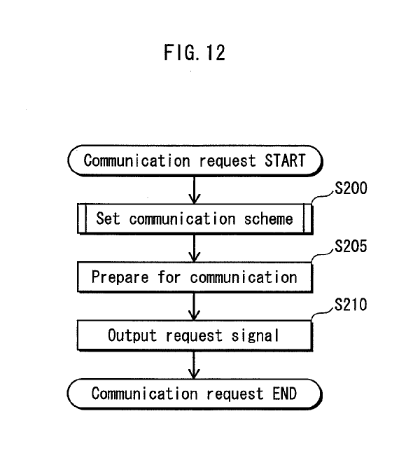

Now, the operations of the communication response processing in Step S105 shown in FIG. 11 will be described, with reference to a flowchart of FIG. 12.

The communication request unit 220 determines the communication scheme which is to be specified to the slave 30, sets the value indicating the determined communication scheme in the communication mode flag 602 (Step S200), and prepares for transmission and reception in accordance with the communication scheme (Step S205).

Subsequently, the communication request unit 220 generates the request signal 60 containing the communication flag 602 which indicates the communication scheme determined in Step S200, and transmits the generated request signal 60 to the slave 30 (Step S210).

### (4) Communication Scheme Setting Processing

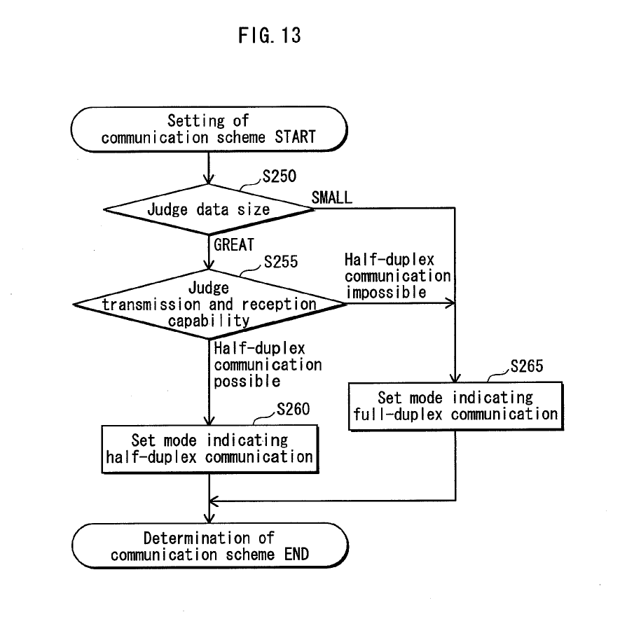

Now, the communication scheme setting processing in Step S200 shown in FIG. 12 will be described, with reference to a flowchart of FIG. 13.

The communication request unit 220 judges whether the size of data that is to be transmitted or received is greater or smaller than the predetermined threshold value (Step S250).

When judging the size of data is smaller (“SMALL” in Step S250), the communication request unit 220 sets a value “0” indicating full-duplex communication as the communication mode in the communication mode flag 602 (Step S265).

When judging the size of data is greater (“GREAT” in Step S250), the communication request unit 220 judges with use of Formula 1, (i) if requesting to write data, whether the calculated buffer size may be secured in the buffer 210, and (ii) if requesting to read data, whether the calculated buffer size may be secured in the buffer 211 (Step S255).

When judging securable, that is to say, half-duplex communication is possible (“half-duplex communication possible” in Step S255), the communication request unit 220 sets the half-duplex communication mode (the value “1”) in the communication mode flag 602 (Step S260). When judging not securable, that is to say, half-duplex communication is not possible, (“half-duplex communication not possible” in Step S255), the communication request unit 220 sets the full-duplex communication mode (the value “0”) in the communication mode flag 602.

### (5) Communication Scheme Selection Processing

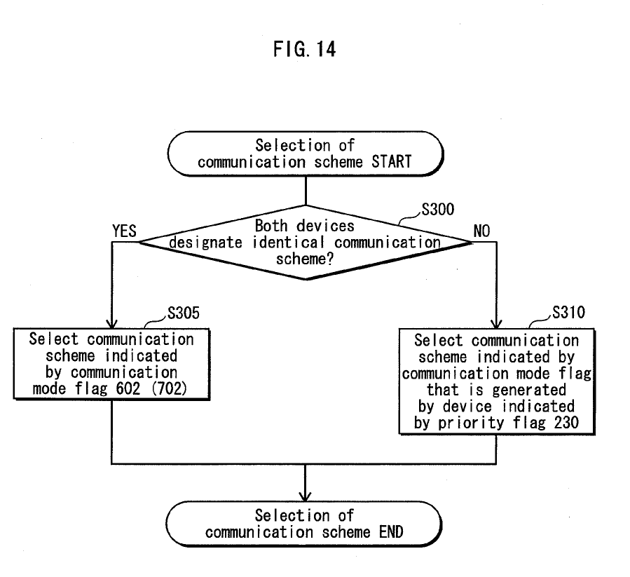

Now, the communication scheme selection processing shown in Step S115 of FIG. 11 will be described, with reference to a flowchart of FIG. 14.

The communication scheme selection unit 221 judges whether the communication mode flag 602 contained in the request signal 60 and the communication mode flag 702 contained in the response signal 70 correspond to each other (Step S300).

When judging that the flag 602 and the flag 702 correspond (“YES” in Step S300), the communication scheme selection unit 221 selects the communication scheme indicated by either the communication flag 602 or the communication flag 702 as the communication scheme for data communication (Step S305).

When judging that the flag 602 and the flag 702 do not correspond (“NO” in Step S 300), the communication scheme selection unit 221 selects, with use of the priority flag 230, the communication scheme indicated by one of the communication mode flags 602, 702 specified by the device which is to take priority as the communication scheme for data communication (Step S 310).

### (6) Operations of Slave 30

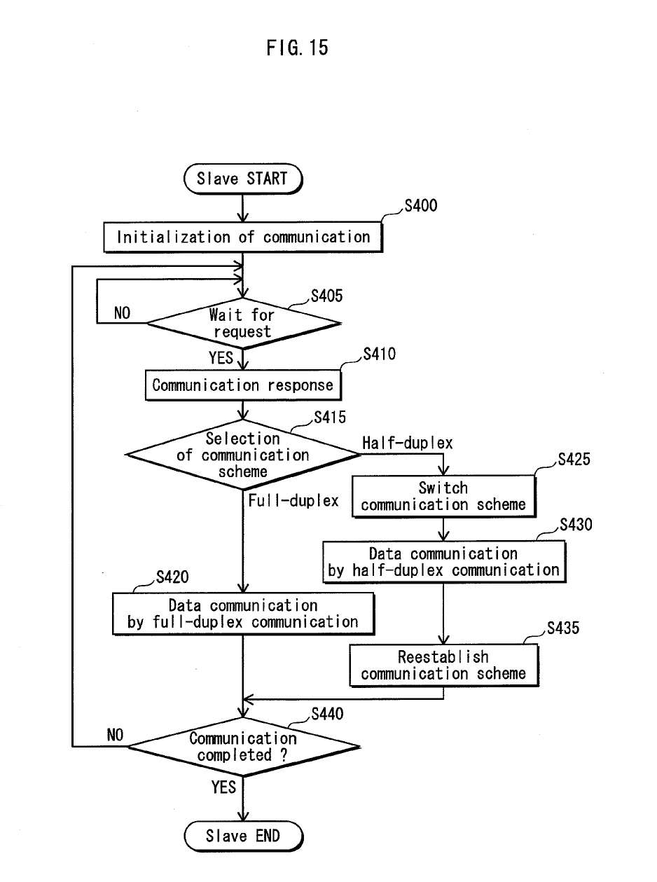

Now, description will be made on the operations of the slave 30 during data communication, with reference to a flowchart of FIG. 15.

The slave 30 executes processing on the slave 30 side in the initialization processing of communication shown in FIG. 10 (Step S400). More specifically, the communication response unit 320 receives the I/O receive request signal 50 from the master 20, and then transmits the control information 503 in accordance with the received I/O receive request signal 50 to the master 20. Subsequently, upon receiving the I/O transmit request signal 51 containing the control information 512 which is to be shared with the master 20, the communication response unit 320 stores the received control information 512 in a predetermined storing area. This enables the master 20 and the slave 30 to share the control information required for communication, thereby providing the ready-for-communication state.

The communication response unit 320 executes processing on the slave 30 side in the communication request processing shown in FIG. 10 (Step S405). More specifically, the communication response unit 320 enters its reception waiting state until it receives the request signal 60 containing the communication mode flag 602 which indicates the communication scheme specified by the master 20, and once the communication response unit 320 receives the request signal 60, the communication response unit 320 moves on to a next step.

The communication response unit 320 executes processing on the slave 30 side in the communication response processing shown in FIG. 10 (Step S410). Here, the communication response unit 320 determines the communication scheme which is to be notified to be the master 20, generates the response signal 70 containing the communication mode flag 702 which indicates the determined communication scheme, and transmits the generated response signal 70 to the master 20. The operations will be described later in details.

The communication scheme selection unit 321 executes the communication mode selection processing shown in FIG. 10, and selects the communication scheme for data communication (Step S415). Here, description on the communication scheme selection processing will be omitted, since it can be achieved in a similar manner as FIG. 14 with use of the communication mode flag 602 (702) and the priority flag 330.

When full-duplex communication is selected for the communication scheme (“full-duplex communication” in Step S415), the slave 30 performs data communication by full-duplex communication as the data communication processing shown in FIG. 10 (Step S420).

When half-duplex communication is selected for the communication scheme (“half-duplex communication” in Step S415), the slave 30 performs operations of Steps S425 to S435 as the data communication processing shown in FIG. 10. Here, the operations of Steps S425 to S435 correspond to the case in which half-duplex communication is performed in the data communication processing shown in FIG. 10.

The communication scheme selection unit 321 switches the communication scheme from the predetermined full-duplex communication scheme to the half-duplex communication scheme (Step S425). More specifically, when the master 20 requests data reception, the communication scheme selection unit 321 controls the differential transmitters 345, 347 to be activated. On the other hand, when the master 20 requests data transmission, the communication scheme selection unit 321 controls the differential receivers 346, 348 to be activated.

The control unit 305 performs data communication by the communication scheme brought about by the switching (Step S430).

Once data transmission or reception comes to an end, the communication scheme selection unit 321 switches the communication scheme to the predetermined communication scheme in order to reestablish the communication scheme (Step S435). More specifically, the communication scheme selection unit 321 controls the differential transmitters 345 and the differential receiver 348 to be activated.

The control unit 305 judges whether communication has been completed or not, that is to say, whether there still exists data which remains to be transmitted or received (Step S440).

If judging that communication has been completed, that is to say, there exists no data to be transmitted or received (“YES” in Step S440), the control unit 305 terminates the processing. If judging that communication has not been completed, that is to say, there still exists data to be transmitted or received (“NO” in Step S440), the processing of the control unit 305 returns to Step S405. Here, the operations in S440 correspond to those on the slave 30 side in the operations in Step S30 in FIG. 10.

### (7) Communication Response Processing

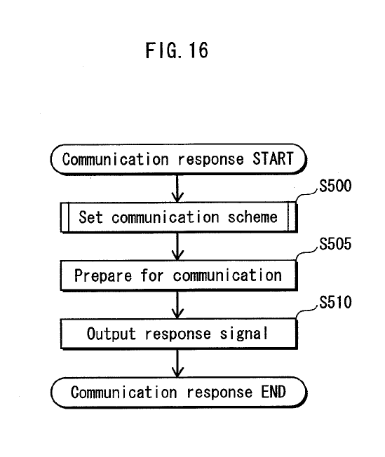

Now, the operations of communication response processing in Step S410 shown in FIG. 15 will be described, with reference to a flowchart of FIG. 16.

The communication response unit 320 determines the communication scheme which is to be specified to the master 20, sets the value indicating the determined communication scheme in the communication mode flag 702 (Step S500), and prepares for transmission and reception in accordance with the communication scheme (Step S505).

Subsequently, the communication request unit 320 generates the response signal 70 containing the communication flag 702 which indicates the communication scheme determined in Step S500, and transmits the generated response signal 70 to the master 20 (Step S510).

Meanwhile, description on the communication scheme setting processing will be omitted here, since it can be achieved in a similar manner to FIG. 13.

### (8) Switching of Communication Scheme

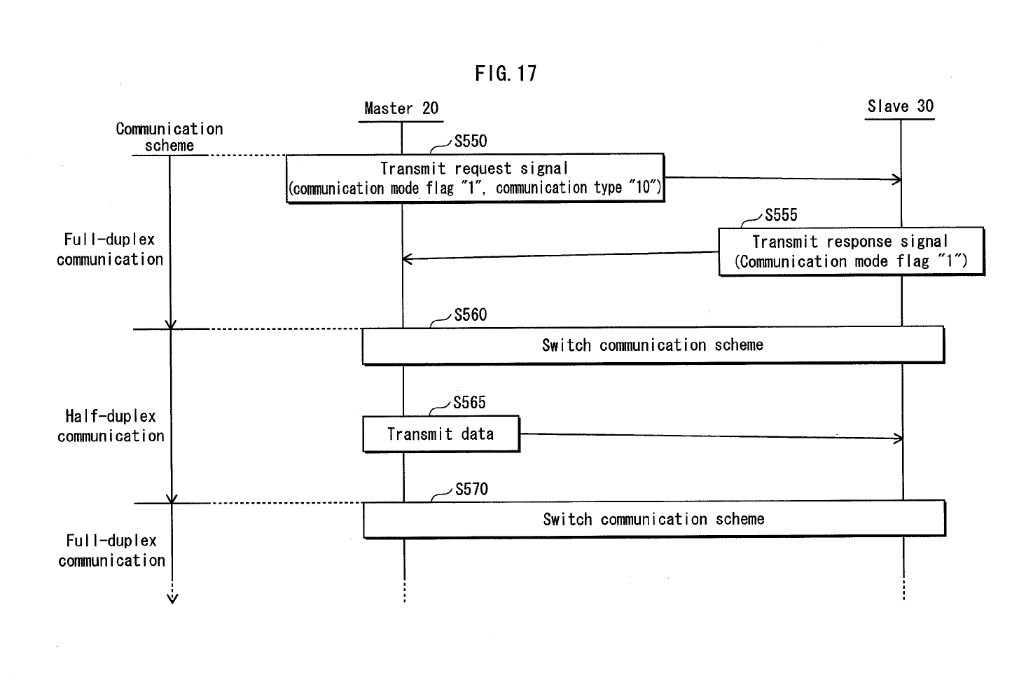

Now then, description will be made on the switching of the communication scheme with reference to a flowchart of FIG. 17. It is assumed that, in the description, the master 20 and the slave 30 have already shared control information.

The master 20 generates the request signal 60 containing the communication type 601 indicating data transmission, as well as the communication mode flag 602 indicating half-duplex communication as the communication scheme, and transmits the generated request signal 60 to the slave 30 (Step S550).

The slave 30 receives the request signal 60, generates the response signal 70 containing the information that communication is available and the communication mode flag 702 indicating the half-duplex as the communication scheme, and transmits the generated response signal 70 to the master 20 (Step S 555).

Each of the master 20 and the slave 30 selects half-duplex communication as the communication scheme with use of the communication mode flags 602, 702 contained in each of the request signal 60 and the response signal 70 respectively, and switches the communication scheme so that each device may perform data communication by half-duplex communication (Step S560).

The master 20 transmits data to the slave 30 by the communication scheme brought about by the switching, that is to say, half-duplex communication (Step S565).

Once data communication comes to an end, the master 20 and the slave 30 switch the communication scheme from half-duplex communication to full-duplex communication (Step S570).

Note that in a period from Step S550 to Step S560 where the communication scheme is switched, full-duplex communication is used as the communication scheme, and that in a period from Step 560 to Step 570 where the communication scheme is switched, half-duplex communication is used, as mentioned above. Besides, in a period from Step S570 to a time when the communication scheme is to be switched next time, full-duplex communication is used as the communication scheme.

### <1.6> Modifications

Although the present invention has been described in accordance with the above embodiment, naturally the present invention is not limited to the above embodiment. On the contrary, the following modifications are included within the scope of the invention.

(1) Although the example formats of data structure of each of the request signal 60 and the response signal 70 were shown in FIG. 3A and FIG. 4A respectively, those example formats are not limiting.

For example, as can be clearly seen from Formula 1, it is also possible, when using the above Formula 1, to perform full-duplex communication in a narrower communication bandwidth, as long as transmit and receive buffers can be secured sufficiently enough to allow for half-duplex communication. Accordingly, as shown in FIG. 3B, it is also possible to set in the communication mode flag 602, besides full-duplex communication and half-duplex communication, an unselected state indicating both full-duplex communication and the half-duplex communication may be possible.

In this case, upon receiving the request signal 60 which contains the communication mode flag 602 indicating the unselected state (a value “10” or “11”), the slave 30 sets either full-duplex communication or half-duplex communication in the communication mode flag 702.

Further, upon receiving the request signal 60 which contains the communication mode flag 602 indicating either full-duplex communication or half-duplex communication, the slave 30 may set a value “10” or “11” indicating the unselected state in the communication mode flag 702, as shown in FIG. 4B.

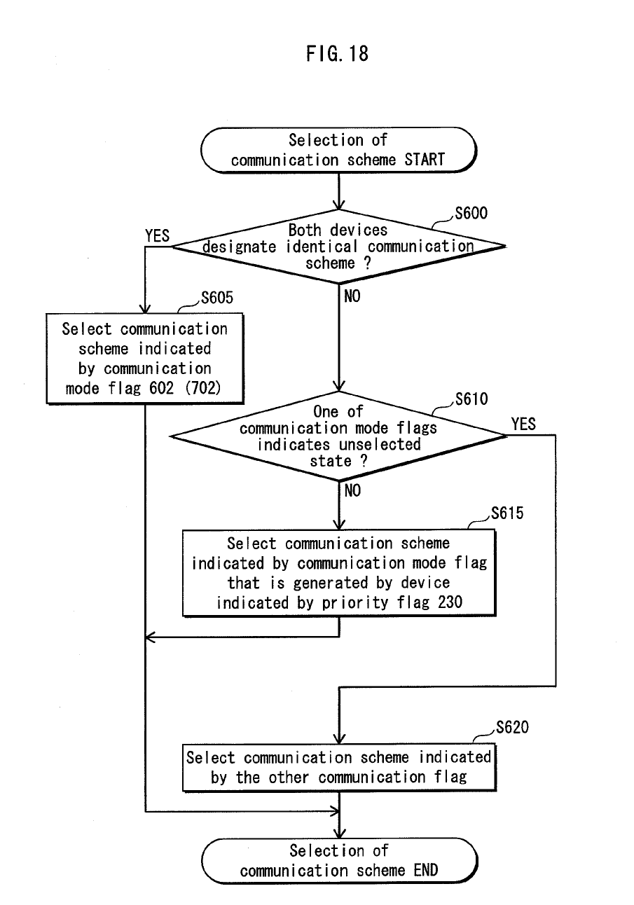

Here, description will be made on the selection processing in the case one of the communication mode flags 602, 702 contains unselected state, with reference to a flowchart of FIG. 18. Note that, although operations on the master 20 side will be explained here, those on the slave 30 side are identical.

The communication scheme selection unit 221 judges whether the communication mode flag 602 contained in the request signal 60 corresponds to the communication mode flag 702 contained in the response signal 70 (Step S600).

When judging that the flag 602 and the flag 702 correspond (“YES” in Step S600), the communication scheme selection unit 221 selects the communication scheme indicated by one of the communication mode flags 602, 702 as the communication scheme for data communication (Step S605).

When judging that the flag 602 and the flag 702 do not correspond (“NO” in Step S600), the communication scheme selection unit 221 judges whether either of the communication mode flags 602 or 702 indicates unselected state (Step S 610).

When judging the unselected state is not set (“NO” in Step S610), the communication scheme selection unit 221 selects, with use of the priority flag 230, the communication scheme indicated by the communication mode flag which is specified by one of the devices which is to take priority, as the communication scheme for data communication (Step S615).

When judging the unselected state is set (“YES” in Step S610), the communication scheme selection unit 221 selects the communication scheme indicated by the communication mode flag other than the communication mode flag in which unselected state is set, as the communication scheme for data communication (Step S620).

(2) In the example format of data structure of the priority flag 230 (330) in the above embodiment, it is shown that the communication scheme specified by either the master 20 or the slave 30 is to take priority.

In this case, the master 20 acquires the communication capability (including the transmit buffer capacity of the transmission unit and the receive buffer capacity of the reception units, and the data processing rate of the processing unit) of the slave 30 as the control information of the slave 30 in the initialization processing of communication, compares the communication capability of the slave 30 with the communication capability of the own device, and shares the priority flag 230 (330), the priority flag 230 (330) putting priority on the device with inferior communication capability. Due to this, when the device with inferior communication capability selects full-duplex communication, it can be prevented that half-duplex communication using a wider bandwidth is selected, thereby realizing reliable communication in accordance with the communication capability of each of the devices. In addition, it can also be envisaged that the priority flag 230 (330) herein houses the priority level that has been set for the master 20 and the slave 30, and that the communication mode selection may be achieved as similarly to the above, by setting such that the lower the communication capability the higher the priority level, for example.

Nevertheless, the method for indicating which communication scheme is to take priority is not limited to the above.

For example, as shown in FIG. 5C, the priority flag 230a (330a) may indicate either that transmission is to take priority or that reception is to take priority.

The communication request unit 220 judges, for each of the master 20 and the slave 30, whether the reception capability thereof is greater than or equal to the communication bandwidth in the half-duplex communication mode. More specifically, it judges whether the receive buffers 211 and 311 can store the amount of data that is to be transmitted in the communication bandwidth in the half-duplex communication. When judging affirmatively, the communication request unit 220 sets the priority flag to place priority on a transmitting device in data communication (priority on transmission), and when judging negatively, it sets the priority flag to place priority on a receiving device in data communication (priority on reception).

For example, in the case of priority on transmission, when the master 20 requests transmission, the communication scheme specified by the master 20 is to take priority, and when the master 20 requests reception, the communication scheme specified by the slave 30 is to take priority. On the other hand, in the case of priority on reception, when the master 20 requests transmission, the communication scheme specified by the slave 30 is to take priority, and when the master 20 requests reception, the communication scheme specified by the master 20 is to take priority.

Accordingly, when the reception capability of each of the master 20 and the slave 30 is less than the reception capability corresponding to the communication bandwidth in the half-duplex communication mode, by placing priority on reception, it becomes possible to select the communication scheme taking into consideration the overflow of the buffer in a receiving device. On the other hand, when the reception capability of each of the devices is greater than or equal to the reception capability corresponding to the communication bandwidth in the half-duplex communication mode, by placing priority on transmission, it becomes possible to select the communication scheme which would allow to make the most use of the send capability of a sending device.

Besides, as can be seen from FIG. 5D, the priority flag 230b (330b) may indicate either that full-duplex communication is to take priority or that half-duplex communication is to take priority.

In this case, even when the communication mode in the request signal 60 differs from the communication mode in the response signal 70, (i) in the case of priority on full-duplex communication, the full-duplex communication mode is selected, and (ii) in the case of priority on half-duplex communication, the half-duplex communication mode is selected. Accordingly, for example, when the communication capability of each of the master 20 and the slave 30 is less than the communication capability corresponding to the communication bandwidth in the half-duplex communication mode, by placing priority on full-duplex communication, it becomes possible to restrict the half-duplex communication mode except when both of the master 20 and the slave 30 select the half-duplex communication mode. On the other hand, when the communication capability of each of the master 20 and the slave 30 is greater than or equal to the communication capability corresponding to the communication bandwidth in the half-duplex communication mode, by placing priority on half-duplex communication, it becomes possible to restrict the full-duplex communication mode except when both the master 20 and the slave 30 select the full-duplex communication mode.

Besides, as shown in FIG. 5E, the priority flag 230c (330c) may house any of the conditions of as shown in the priority flags of FIGS. 5B to 5D.

(3) In the above embodiment, the master 20 and the slave 30 share the priority flag in the initialization processing of communication before data communication starts, and the priority flag remains static during data communication, but the present invention is not limited to the embodiment.

For example, as shown in FIG. 3C, the master 20 may house the priority level 610 in the request signal 60 and transmits the request signal to the slave 30 when selecting the communication scheme. In this case, one of the values shown in FIG. 5B is set as the priority level 610. Meanwhile, since the determination and setting of the priority level value is similar to the above embodiment, description will be omitted here.

Alternately, as shown in FIG. 4C, the format of the response signal 70 which contains the priority level 710 can also be envisaged. In this case, one of the values shown in FIG. 5B is set as the priority level 710. Meanwhile, since the determination and setting of the priority level value is similar to the above embodiment, description will be omitted here.

This enables the master 20 and the slave 30 to set, in the communication scheme setting processing, the communication scheme and the priority level simultaneously, and to select, in the communication scheme selection processing, the communication scheme taking priority higher than the other from those indicated in the respective communication mode flags in the request signal and the response signal.

(4) Although switching from half-duplex communication to the predetermined scheme (full-duplex communication) is performed by the communication scheme selection unit 221 in the above embodiment, the present invention is not limited to the embodiment. The switching can be performed by any other component.
(5) Although the capabilities of the devices are compared with use of the buffer capacity in the above embodiment, the present invention is not limited to the embodiment.

For example, when adapting channels conforming to USB 2.0, IEEE 1394, PCI Express, or the like, which deal with differential signals driven by current for the purpose of high speed serial communication, switching of the direction of the channels involves switching overhead corresponding to transfer time ranging from as many as tens of bits to a few thousand bits. This is because of that the switching of the direction of the channels requires switching of current direction between two communication devices, therefore transmission and reception of preambles in order to stabilize the channels or to perform bit synchronization. Thus, the above overhead (switching time) may be used in comparison between the capabilities of the devices when switching the communication mode.

(6) Although it is assumed that the master 20 performs batch data transmission or batch data reception in the above embodiment, the present invention is not limited to the embodiment.

Each piece of data that is to be transmitted or received may be divided into a plurality of blocks for transmission and reception.

The operations of the master 20 and the slave 30 in this case will be explained below.

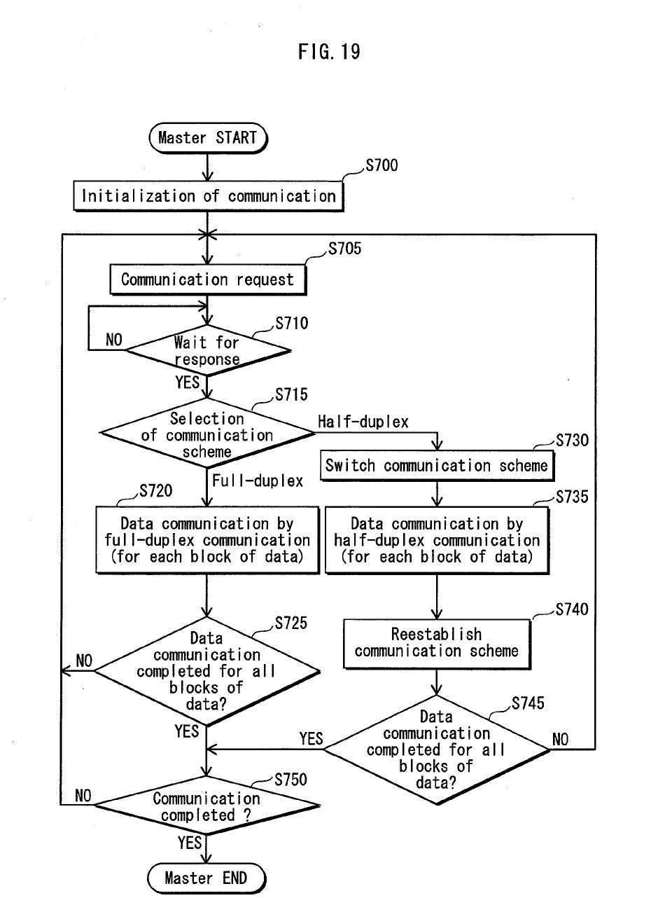

Firstly, description on the operations of the master 20 will be described, with reference to a flowchart of FIG. 19.

The master 20 executes processing on the master 20 side in the initialization processing of communication shown in FIG. 10 (Step S700).

The communication request unit 220 executes processing on the master 20 side in the communication request processing shown in FIG. 10 (Step S705). Meanwhile, since the communication request processing can be achieved in a same manner as FIG. 12 and FIG. 13, detailed description will be omitted here.

The communication request unit 220 executes processing on the master 20 side in the communication response processing shown in FIG. 10 (Step S710).

After receiving the response signal 70 from the slave 30 (“YES” in Step S710), the communication scheme selection unit 221 executes the communication scheme selection processing shown in FIG. 10, and selects the communication scheme for data communication (Step S715). Meanwhile, since the communication mode selection processing can be achieved in a same manner as FIG. 14, detailed description will be omitted here.

When full-duplex communication is selected for the communication scheme (“full-duplex communication” in Step S715), the master 20 (for example, the control unit 205) performs data communication by full-duplex communication with respect to each of the plurality of blocks of data to be communicated (Step S720). Once data communication with respect to each of the plurality of blocks of data comes to end, the master 20 (for example, the control unit 205) judges whether data communication has been completed with respect to all of the plurality of blocks of data to be communicated (Step S725).

When judging data communication with respect to all of the plurality of blocks of data has been completed (“YES” in Step S725), the control unit 205 judges whether the communication has been completed or not, that is to say, whether there still exists another piece of data which remains to be transmitted or received (Step S 750).

If judging the communication has been completed, that is to say, there exists no data that remains to be transmitted or received (“YES” in Step S750), the control unit 205 terminates the processing. If judging the communication has not been completed, that is to say, there still exists another piece of data that remains to be transmitted or received (“NO” in Step S750), the processing of the control unit 205 returns to Step S705 to select the communication scheme for a subsequent block of data to be transmitted and perform data communication.

When judging data communication with respect to all of the plurality of blocks of data has not been completed (“NO” in Step S725), the processing of the control unit 205 returns to Step S705 to select the communication scheme for a subsequent block of data to be communicated and perform data communication.

When half-duplex communication is selected for the communication scheme (“half-duplex communication” in Step S715), the master 20 performs operations of Steps S730 to S740 as the data communication processing shown in FIG. 10. Meanwhile, since the operations of Steps S730 to S740 correspond to those of Steps S125 to S135 shown in FIG. 11, description will be omitted here.

Once the communication scheme is switched to the predetermined scheme in Step S740, the control unit 205 judges whether data communication has been completed with respect to all of the plurality of blocks of data to be communicated (Step S745).

When judging data communication has been completed with respect to all of the plurality of blocks of data (“YES” in Step S745), the control unit 205 moves on to Step S750. When judging it has not been completed (“NO” in Step S745), the processing of the control unit 205 returns to Step S705 to select the communication scheme for a subsequent block of data to be communicated and perform data communication.

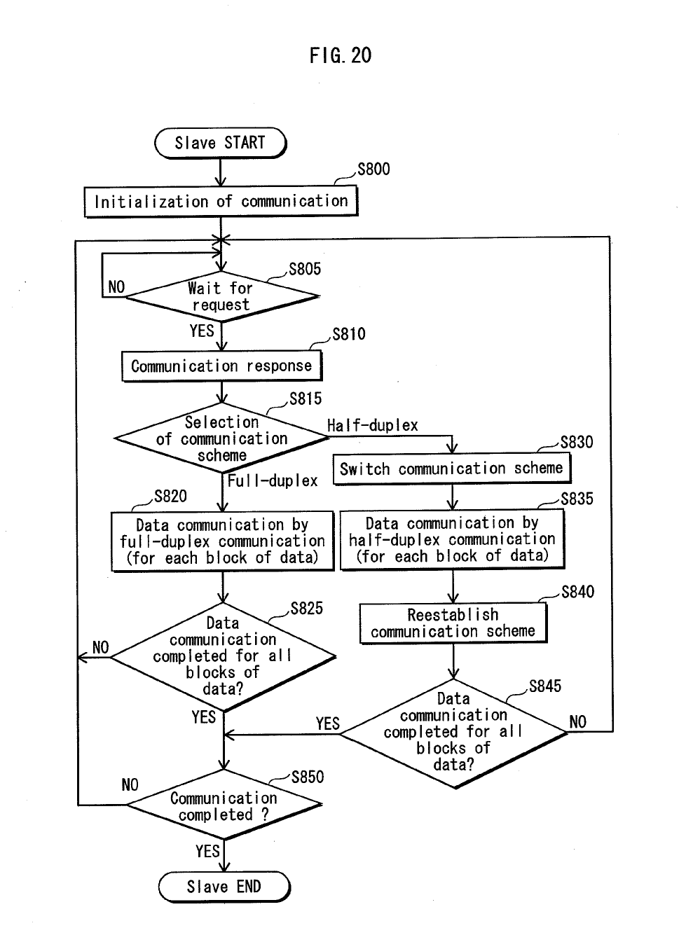

Next, description will be made on the operations of the slave 30, with reference to a flowchart of FIG. 20.

The slave 30 executes processing on the slave 30 side in the initialization processing of communication shown in FIG. 10 (Step S800).

The communication response unit 320 executes processing on the slave 30 side in the communication request processing shown in FIG. 10 (Step S805).

When receiving the request signal 60 from the master 20 (“YES” in Step S805), the communication response unit 320 executes processing on the slave 30 side in the communication response processing shown in FIG. 10 (Step S810). Meanwhile, since the communication response processing can be achieved in a same manner as FIG. 15, detailed description will be omitted here.

The communication scheme selection unit 321 executes the communication mode selection processing shown in FIG. 10, and selects the communication scheme for data communication (Step S815). Meanwhile, since the communication scheme selection processing can be achieved in a same manner as FIG. 14, detailed description will be omitted here.

When full-duplex communication is selected for the communication scheme (“full-duplex communication” in Step S815), the slave 30 (for example, the control unit 305) performs data communication by full-duplex communication with respect to each of the plurality of blocks of data to be communicated (Step S820). Once data communication with respect to each of the plurality of blocks of data comes to end, the slave 30 (for example, the control unit 305) judges whether data communication has been completed with respect to all of the plurality of blocks of data to be communicated (Step S825).

When judging data communication has been completed with respect to all of the plurality of blocks of data (“YES” in Step S825), the control unit 305 judges whether the communication has been completed or not, that is to say, whether there still exists another piece of data which remains to be transmitted or received (Step S 850).

If judging the communication has been completed, that is to say, there exists no data that remains to be transmitted or received (“YES” in Step S850), the control unit 305 terminates the processing. If judging the communication has not been completed, that is to say, there still exists another piece of data that remains to be transmitted or received (“NO” in Step S850), the processing of the control unit 305 returns to Step S805 to select the communication scheme for subsequent data and perform data communication.

When judging data communication has not been completed with respect to all of the plurality of blocks of data (“NO” in Step S825), the processing of the control unit 305 returns to Step S805 to select the communication scheme for a subsequent block of data to be communicated and perform data communication.

When half-duplex communication is selected for the communication scheme (“half-duplex communication” in Step S815), the slave 30 performs operations of Steps S830 to S840 as the data communication processing shown in FIG. 10. Meanwhile, since the operations of Steps S830 to S840 correspond to those of Steps S425 to S435 shown in FIG. 15, description will be omitted here.

Once the communication scheme is switched to the predetermined scheme in Step S840, the control unit 305 judges whether data communication has been completed with respect to all of the plurality of blocks of data to be communicated (Step S845).

When judging data communication has been completed with respect to all of the plurality of blocks of data (“YES” in Step S845), the processing of the control unit 305 moves on to Step S850. When judging data communication has not been completed with respect to all of the plurality of blocks of data (“NO” in Step S845), the processing of the control unit 305 returns to Step S805 to select the communication scheme for a subsequent block of data to be communicated and perform data communication.

As mentioned above, once data communication of one block of data by half-duplex communication comes to an end, each of the master 20 and the slave 30 switches to full-duplex communication. This is due to the fact that interruption may occur in the half-duplex communication once data communication of one block of data comes to an end. For example, when an error, such as a CRC error, occurs in a receiving device in the half-duplex communication, the receiving device switches to full-duplex communication and then notifies the data transmitting device of the error, thereby enabling the sending device to send the same block of data again. This is because of that, since in the half-duplex communication, the set of channels is used in one direction, two-way communication is not possible. Therefore, by reestablishing or switching to full-duplex communication and sending an error message (abort message), it is possible to abort (compulsorily stops) processing with respect to the block of data.

(7) Although the request signal includes the size of data that is to be transmitted or received in the above embodiment, the present invention is not limited to the above embodiment.

It can also be envisaged that the request signal does not house the size of data that is to be transmitted or received.

In this case, when the master 20 transmits data to the slave 30 or receives data from the slave 30, once the data transmission or reception comes to an end, subsequently the master 20 transmits, as another piece of data, a completion message to the slave 30, telling that the data transmission or reception has been completed.

For example, when the master 20 transmits data to the slave 30 by half-duplex communication, after data transmission comes to an end, the master 20 switches to full-duplex communication once. On the slave 30 side, after receiving the data transmitted from the master 20 by half-duplex communication, the slave 30 also switches to full-duplex communication once. Then, in order to transmit or receive the completion message, each of the master 20 and the slave 30 selects the communication scheme with use of the communication mode flags contained in the request signal and the response signal, and transmits or receives the message in the selected communication scheme.

Again, for example, when the master 20 receives data from the slave 30 by half-duplex communication, when data reception comes to an end, the master 20 switches to full-duplex communication once, as is similar to the case of data transmission. On the slave 30 side, after transmitting the data to the master 20 by half-duplex communication, the slave 30 also switches to full-duplex communication once. Then, in order to transmit or receive the completion message, each of the master 20 and the slave 30 selects the communication scheme as similarly to the above, and transmits or receives the message in the selected communication scheme.

The following reason explains why each of the master 20 and the slave 30 switches to full-duplex communication once data communication of one block of data by half-duplex communication comes to an end, as mentioned above. The reason is that, as is similar to the case of data communication in a block unit, when an error, such as the overflow of the buffer, occurs in a receiving device, interruption may take place in order to notify the data transmitting device of the error.

(8) Although the relation between the master 20 and the slave 30 remains static in the present embodiment, the present invention is not limited to the above embodiment. It is also envisaged that the control unit of each of the devices comprises the communication request unit and the communication response unit. This would allow the relation between the master 20 and the slave 30 to be replaced dynamically. For example, the relation between the master 20 and the slave 30 may be switched each time communication is performed.
(9) Here, the slave device may be a memory card or an I/O card which are detachable from the master 20. For example, the memory card is an SD card, and the I/O card is a wireless LAN card for performing wireless communication with the devices.

Now, description will be made on the case in which the slave is replaced by an SD card.

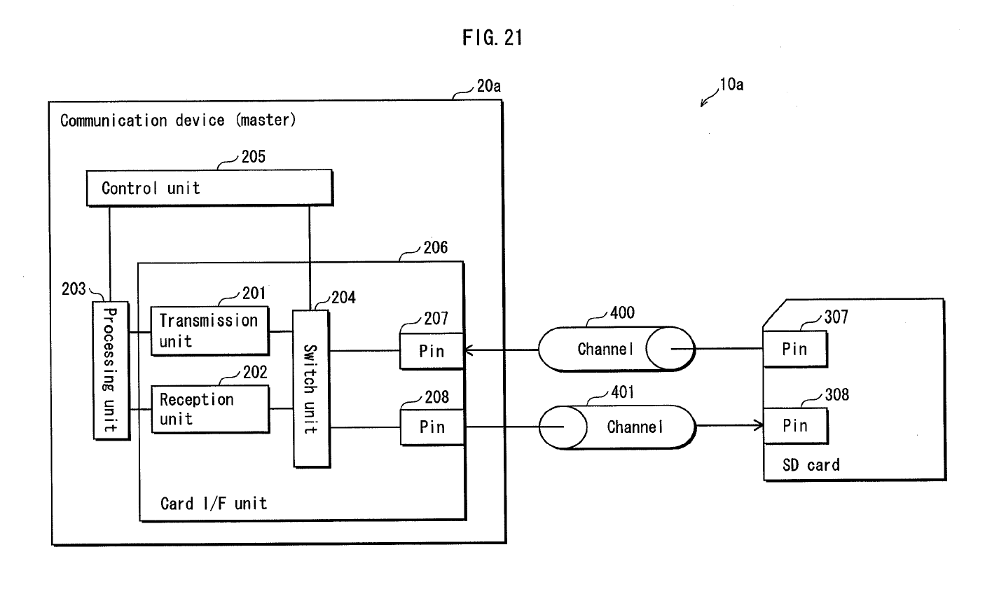

FIG. 21 shows structure of a communication system 10a, in which the above slave 30 is replaced by the SD card 30a, the communication system 10a comprising the master 20a and the SD card 30a. In the description below, some of the components that are represented by the same numerals as the master 20 and the slave 30 of the above embodiment denote identical components, and description will be omitted.

As shown in FIG. 21, the master 20a includes a processing unit 203, a control unit 205, and a card I/F unit 206.

The card I/F unit 206 performs data communication with the SD card 30a attached to the master 20, and as shown in FIG. 21, includes a transmission unit 201, a reception unit 202, a switch unit 204, and pins 207, 208.

The pins 207, 208 are connected with the SD card 30a.

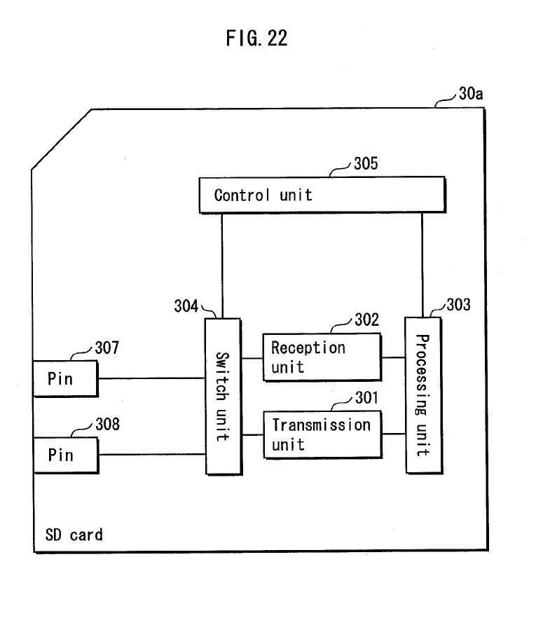

As shown in FIG. 22, the SD card 30a includes pins 306, 307, as well as the components of the slave 30.

Each of the pins 306, 307 is connected with the pins 207, 208 of the card I/F unit 206 respectively, when the SD card 30a is attached to the master 20.

Thus, by connecting the pin 207 with the pin 307, the above channel 400 is formed, and by connecting the pin 208 with the pin 308, the above channel 401 is formed, respectively. Since the connection of the channels 400, 401 with the switch units 204, 304 may be achieved in a similar manner to FIG. 6 and FIG. 7 in the above embodiment, description will be omitted here.

The connection as mentioned above enables the master 20a and the SD card 30a to perform full-duplex communication and half-duplex communication via the channels 400, 401, as is similar to the above embodiment.

Meanwhile, since the case of an I/O card can be achieved in a similar manner, description will be omitted here.

(10) Although the data processing time (data transferring rate) is used for comparison of the processing capabilities when setting the priority flag in the above embodiment, the present invention is not limited to the above embodiment. Any information that would allow the comparison between the processing capability of the master 20 and the processing capability of the slave 30 may be used instead. For example, it can be envisaged to use the receive buffer capacity and the transmit buffer capacity, and any combination of these.
(11) In the above embodiment, when the communication scheme indicated in the communication flag set by the master 20 differs from the communication scheme indicated in the communication flag set by the slave 30, the communication scheme is determined with use of the priority flag.

For example, it is assumed that, when the priority flag indicates priority on the slave, and when the master 20 specifies full-duplex communication despite that the master 20 is capable of half-duplex communication, the slave 30 specifies the communication scheme different from the master 20. By use of the priority flag, it becomes possible to cause the both devices to select half-duplex communication. Since the selected communication scheme does not exceed the communication processing capability of each of the devices, communication efficiency does not decrease.

However, the selection method in the case there is discrepancy in the communication scheme is not limited to the above method using the priority flag.

It is also possible to ensure that, when the communication scheme indicated by the communication flag set by the master 20 differs from the communication scheme indicated by the communication flag set by the slave 30, full-duplex communication is always selected.

In this case, neither the master 20 nor the slave 30 needs to include an area that stores the priority flag. Further, if the size of data to be communicated is small, it is advantageous, when there is discrepancy in the communication scheme, to select full-duplex communication. In such a case, the request from the slave is not necessary, for the master 20 has only to specify half-duplex communication as a basic communication scheme and to specify full-duplex communication when the data size is small.

In contrast, it is also possible to ensure that, when there is discrepancy in the communication scheme, half-duplex communication is selected.

This is advantageous, for example, in data communication with flow control.

In data communication with the flow control, data communication cannot be commenced until confirmation is made that each device is ready for communication, and so any communication mode can be possible. In such a case, it is more advantageous to place priority on half-duplex communication to transfer accumulated data at an early stage.

An example of the flow control will be described below.

When requesting to write data, the master 20 prepares data to be written and then notifies the slave 30. Upon receiving the notification, the slave 30 secures free buffer having a size equal to the data to be written, and then notifies the master 20. For the data that is to be written, transfer cannot be commenced prior to the notifications from each of the devices. In contrast, when requesting to read data, the master 20 secures free buffer and the slave 30 prepares data to be read, and then the master 20 and the slave 30 notify each other to commence data transfer. In such a case with the flow control where data communication cannot be commenced until each of the devices becomes ready for data transfer, it is advantageous to place priority on the half-duplex communication.

Moreover, in data communication with back pressure type flow control, it is possible, when there is discrepancy in the communication scheme, to select either full-duplex communication or half-duplex communication in accordance with the storage state in the buffer of a receiving device.

In the back pressure type flow control, data transfer is commenced before accumulating the data, and a wait signal is notified when the overflow of a receive buffer is likely to occur. In this case, it is not effective, when there is discrepancy in the communication scheme, to assure that half-duplex communication is always selected. This is because that it is necessary for a data receiving device to send a wait signal to a data transmitting device as needed, and that the wait signal cannot be sent if both two channels are used in one direction from the data transmitting device to the data receiving device.

Accordingly, when the slave 30 sends the response signal back to the master 20, it is advantageous for the slave 30, if data has been already accumulated in a receiving device, to place priority on half-duplex communication, and if not, to place priority on full-duplex communication so that the slave 30 may send a wait signal.

(12) The communication processing capability referred to herein includes, as mentioned above, the buffer capacity, the communication scheme switching time, the data processing speed, and the buffer size which is to be secured during communication as calculated with use of Formula 1.
(13) In the above embodiment, the communication request unit 220 may send a priority flag to the slave 30 as control information.

Further, the processing unit 203 may include (a) a data processing circuit that (i) performs desired processing on the data which was input from the reception unit 202 and (ii) outputs the processing result to the transmission unit 201, or (b) a memory that (i) stores the data which was input from the reception unit 202 and (ii) outputs the data required by the transmission unit 201.

(14) The present invention also includes the above method. Moreover, the present invention also includes a computer program for executing the method by a computer, or a digital signal comprising the computer program.

The present invention also includes a computer readable storing medium, such as a flexible disk, a hard disk, a CD-ROM, an MO, a DVD, a DVD-ROM, a DVD-RAM, a BD (Blu-ray Disc), a semiconductor memory, in which the computer program or the digital signal is stored. Moreover, the present invention also includes the digital signal stored in such a storing medium.

Further, the present invention also includes a transmission system for transmitting the computer program or the digital signal via an electrical communication line, a wireless or wired communication line, a network represented by the Internet, and data broadcasting.

Besides, the present invention also includes a computer system having a microprocessor and a memory, the memory storing the computer program and the microprocessor operating in accordance with the computer program.

Moreover, by storing the program or the digital signal in the storing medium, or by transferring the program or the digital signal via the network and the like, it is also possible to execute the program or the digital signal by another separate computer system.

(15) Any combination of the above embodiment and any of the above modifications may also be envisaged.

### <1.7> Others

(1) The present invention relates to a communication system in which a plurality of communication devices are connected via a plurality of channels capable of full-duplex communication and half-duplex communication, the communication devices having a relation of a master and a slave, and performing handshaking using a request signal and a response signal and thereafter performing data communication. The master communication device includes a communication request unit for outputting the request signal containing the communication mode flag which indicates that communication mode for data communication is to be either full-duplex communication or half-duplex communication. The slave communication device includes a communication response unit for, upon receiving the request signal, outputting a response signal containing the communication mode flag which indicates that communication mode for data communication is to be either full-duplex communication or half-duplex communication. The master communication device and the slave communication device respectively include a communication mode selection unit for selecting the communication mode in accordance with the communication mode flags contained in the request signal and the response signal, and a data communication unit for performing data communication after switching the plurality of channels to the communication mode selected by the communication mode selection unit.

Accordingly, in the communication system, either the full-duplex communication mode or the half-duplex communication mode is selected, with taking into consideration the transmission and reception processing capabilities of the communication devices.

(2) Here, the communication request unit may output a request signal containing the communication mode flag which indicates one of full-duplex communication, half-duplex communication, and the unselected state of communication mode, and when the request signal indicates the unselected state of communication mode, the communication mode selection unit may select the communication mode indicated by the communication mode flag contained in the response signal.

Similarly, the communication response unit may output a response signal containing the communication mode flag which indicates one of full-duplex communication, half-duplex communication, and the unselected state of communication mode, and when the response signal indicates the unselected state of communication mode, the communication mode selection unit may select the communication mode indicated by the communication mode flag contained in the request signal.

Alternately, the communication request unit may output a request signal containing the communication mode flag which indicates one of full-duplex communication, half-duplex communication, and the unselected state of communication mode, while the communication response unit also outputs a response signal containing the communication mode flag which indicates one of full-duplex communication, half-duplex communication, and the unselected state of communication mode.

Accordingly, in the communication system, the communication mode is switched to either to the communication mode specified by the master or to the communication mode specified by the slave, each time communication is performed.

(3) Here, when it is not possible to decide the communication mode uniquely merely by the communication mode flags contained in the request signal and the response signal, the communication mode selection unit may select the communication mode in accordance with the priority flag which indicates either that the master is to take priority or that the slave is to take priority as predetermined between the master and the slave.

Or, when it is not possible to decide the communication mode uniquely merely by the communication mode flags contained in the request signal and the response signal, the communication mode selection unit may select the communication mode in accordance with the priority flag which indicates either that transmission is to take priority or that reception is to take priority as predetermined between the master and the slave.

Also, when it is not possible to decide the communication mode uniquely merely by the communication mode flags contained in the request signal and the response signal, the communication mode selection unit may select the communication mode in accordance with the priority flag which indicates either that full-duplex communication is to take priority or that half-duplex communication is to take priority as predetermined between the master and the slave.

Further, when it is not possible to decide the communication mode uniquely merely by the communication mode flags contained in the request signal and the response signal, the communication mode selection unit may select the communication mode that is output from the device having the communication processing capability inferior to the other device between the master and the slave.

Alternately, it may be also envisaged that the communication request unit outputs a request signal further including the priority level with respect to selection of the communication mode, and that the communication response unit outputs a response signal further including the priority level with respect to selection of the communication mode. In this case, when it is not possible to decide the communication mode uniquely merely by the communication mode flags contained in the request signal and the response signal, the communication mode selection unit may select the communication mode in accordance with the priority level.

Accordingly, in the communication system, the communication mode is uniquely selected, even when the communication mode specified by the master differs from the communication mode specified by the slave.

(4) Here, the communication request unit may output a request signal containing the communication mode flag which indicates, when data communication to be commenced is an I/O access for exchanging control information between communication devices, full-duplex communication, and indicates, when data communication to be commenced is a memory access for reading and writing a data payload, half-duplex communication.

Accordingly, in the communication system, the communication mode conforming to communication characteristics, such as the data size and latency requirement, is used.

### INDUSTRIAL APPLICABILITY

The present invention is characterized in that each of a master and a slave selects, each time communication is performed, either full-duplex communication or half-duplex communication in accordance with the transmission and reception capability of the master and the transmission and reception capability of the slave, and that handshaking is performed in advance to data communication so that the communication mode may be uniquely selected, and may be applied and used in any communication system that performs an effective data transfer among a plurality of apparatuses, or among function blocks in an apparatus.

Further, the master 20 and the slave 30 of the present invention may be used administratively, that is to say, repeatedly and continuously, in any industry that manufactures and sells a device.

### REFERENCE SIGNS LIST

10: data communication system
20: communication device (master)
30: communication device (slave)
40: set of channels
201: transmission unit
202: reception unit
203: processing unit
204: switch unit
205: control unit
301: transmission unit
302: reception unit
303: processing unit
304: switch unit
305: control unit
400, 401: channel

1-16. (canceled)

17. A data communication system including first and second devices that are capable of performing full-duplex communication and half-duplex communication via a set of channels connecting the first and second devices, wherein
full-duplex communication is established at initialization,
the devices each include an initialization unit operable to enable each other to share selection information at initialization, the selection information helping each device to select either full-duplex communication or half-duplex communication in compliance with a procedure predetermined between the devices,
the first device includes
(i) a communication request unit operable to generate a request signal containing a first communication flag and transmit the generated request signal to the second device via the set of channels, the first communication flag indicating whether half-duplex communication is to be specified in accordance with a capability of the first device,
(ii) a first selection unit operable to receive, from the second device, a response signal containing a second communication flag in response to the request signal and select either the full-duplex communication scheme or the half-duplex communication scheme depending on the first communication flag, the second communication flag, and the selection information in compliance with the procedure, the second communication flag indicating whether half-duplex communication is to be specified in accordance with a capability of the second device, and the selected communication scheme conforming to the capability of each device, and
(iii) a first communication unit operable to perform data communication in the selected communication scheme, and
the second device includes
(i) a communication response unit operable to generate the response signal containing the second communication flag in response to the received request signal and transmit the generated response signal to the first device via the set of channels,
(ii) a second selection unit operable to select either the full-duplex communication scheme or the half-duplex communication scheme depending on the first communication flag, the second communication flag, and the selection information in compliance with the procedure, the selected communication scheme conforming to the capability of each device, and
(iii) a second communication unit operable to perform data communication in the selected communication scheme.

18. The data communication system of claim 17, wherein
the selection information has a priority flag that indicates either that the first device is to take priority or that the second device is to take priority,
the initialization unit of the first device receives information with respect to the capability of the second device, generates the priority flag in accordance with the capability of each device, stores the generated priority flag in a predetermined first storage area, and transmits it to the second device,
upon reception of the priority flag, the initialization unit of the second device stores the received priority flag in a predetermined second storage area, and
the procedure includes the steps of
judging whether an indication of the first communication flag accords with an indication of the second communication flag, and
when judging affirmatively, selecting a communication scheme in accordance with the indication, and
when judging negatively, causing the first and second selection units to select a communication scheme indicated by the communication flag generated by one of the devices which is to take priority, depending on the priority flags stored in the first and second storage areas respectively.

19. The data communication system of claim 18, wherein
the capability includes a buffer capacity used for data reception,
the request signal includes a communication type indicating either that the first device requests to transmit data or that the first device requests to receive data,
the communication request unit judges whether each device has a buffer capacity sufficient enough to secure an amount of data that is to be transmitted in a half-duplex communication bandwidth, and when judging affirmatively, generates a priority flag indicating that a data transmitting device is to take priority, and when judging negatively, generates a priority flag indicating a data receiving device is to take priority,
the first and second selection units select, when the priority flag indicates that the data transmitting device is to take priority, a communication scheme indicated by a communication flag generated by the data transmitting device depending on the communication type, and select, when the priority flag indicates that the data receiving device is to take priority, a communication scheme indicated by a communication flag generated by the data receiving device depending on the communication type.

20. The data communication system of claim 18, wherein
the initialization unit of the first device receives information with respect to the capability of the second device, compares the capability indicated by the received information with the capability of the first device, and generates a priority flag indicating that one of the devices having the capability inferior to the other is to take priority according to a comparison result of the initialization unit, and
the first and second selection units select, when the priority flag indicates that the first device is to take priority, a communication scheme indicated by the first communication flag, and select, when the priority flag indicates that the second device is to take priority, a communication scheme indicated by the second communication flag.

21. The data communication system of claim 17, wherein
the selection information has a priority flag that indicates either that full-duplex communication is to take priority or that half-duplex communication is to take priority,
the initialization unit of the first device receives information with respect to the capability of the second device, stores the priority flag in a predetermined first storage area, and transmits it to the second device, the priority flag indicating that (i) full-duplex communication is to take priority, when the capability of at least one of the devices is not sufficient enough to perform half-duplex communication, and (ii) half-duplex communication is to take priority, when the capability of each device is sufficient enough to perform half-duplex communication,
upon reception of the priority flag, the initialization unit of the second device stores the received priority flag in a predetermined second storage area,
the procedure includes the steps of
judging whether an indication of the first communication flag accords with an indication of the second communication flag, and
when judging affirmatively, selecting a communication scheme in accordance with the indication, and
when judging negatively, causing the first and second selection units to select a communication scheme which is to take priority, depending on the priority flags stored in the first and second storage areas respectively.

22. The data communication system of claim 17, wherein
the first communication flag indicates one of that (i) half-duplex communication is to be specified, (ii) full-duplex communication is to be specified, and (iii) either half-duplex communication or full-duplex communication is possible,
when the first communication flag contained in the request signal indicates that either half-duplex communication or full-duplex communication is possible, the communication response unit houses the second communication flag in the response signal, the second communication flag indicating either that full-duplex communication is to be specified or that half-duplex communication is to be specified, and
the procedure includes a step of
selecting, when the first communication flag indicates that either half-duplex communication or full-duplex communication is possible, a communication scheme indicated by the second communication flag.

23. The data communication system of claim 17, wherein
the first communication flag indicates either that half-duplex communication is to be specified or that full-duplex communication is to be specified,
the second communication flag indicates one of that (i) half-duplex communication is to be specified, (ii) full-duplex communication is to be specified, and (iii) either half-duplex communication or full-duplex communication is possible, and
the procedure includes a step of
selecting, when the second communication flag indicates that either half-duplex communication or full-duplex communication is possible, a communication scheme indicated by the first communication flag.

24. The data communication system of claim 17, wherein
the communication request unit judges whether data that is to be communicated has a size equal to or greater than a predetermined size, and thereafter houses, when the size of data is less than the predetermined size, a first communication flag indicating that a half-communication is not to be specified in the request signal, and houses, when the size of data is equal to or greater than the predetermined size, a first communication flag in accordance with the capability of the first device in the request signal, and
the communication response unit judges whether data that is to be communicated has a size equal to or greater than a predetermined size, and thereafter houses in the response signal, when the size of data is less than the predetermined size, a second communication flag indicating that half-duplex communication is not to be specified, and houses, when the size of data is equal to or greater than the predetermined size, a second communication flag in accordance with the capability of the second device.

25. A data communication request device that transmits a data communication request to an other device via a set of channels connecting the data communication request device and the other device, which are capable of performing full-duplex communication and half-duplex communication, comprising:
an initialization unit operable to enable the data communication request device and the other device to share selection information at initialization where full-duplex communication is established, the selection information helping each device to select either full-duplex communication or half-duplex communication in compliance with a procedure predetermined between the devices;
a communication request unit operable to generate a request signal containing a first communication flag and transmit the generated request signal to the other device via the set of channels, the first communication flag indicating whether half-duplex communication is to be specified in accordance with a capability of the data communication request device;
a selection unit operable to receive, from the other device, a response signal containing a second communication flag in response to the request signal, and select either a full-duplex communication scheme or a half-duplex communication scheme depending on the first communication flag, the second communication flag, and the selection information in compliance with the procedure, the second communication flag indicating whether half-duplex communication is to be specified in accordance with a capability of the other device, and the selected communication scheme conforming to the capability of each device; and
a communication unit operable to perform data communication in the selected communication scheme.

26. The data communication request device of claim 25, wherein
the selection information has a priority flag that indicates either that the data communication request device is to take priority or the other device is to take priority,
the initialization unit receives information with respect to the capability of the other device, compares the capability indicated by the received information with the capability of the data communication request device, stores the priority flag in a predetermined storage area, and transmits it to the other device, the priority flag indicating one of the devices having the capability inferior to the other according to a comparison result of the initialization unit,
the procedure includes the steps of
judging whether an indication of the first communication flag accords with an indication of the second communication flag, and
when judging affirmatively, selecting a communication scheme in accordance with the indication, and
when judging negatively, causing the selection unit to select a communication scheme indicated by the communication flag generated by one of the devices which is to take priority depending on the priority flag stored in the predetermined storage area.

27. The data communication request device of claim 26, wherein
in the data communication, data transmission and reception is performed for a plurality of times via the set of channels,
each time data is transmitted and received, a request signal is generated and transmitted, and
in generating a request signal with respect to data transmission and reception for a second time or later on, the communication request unit compares a current capability of the data communication request device with the capability of the other device, updates the priority flag stored in the predetermined storage area according to a comparison result of the communication request unit, generates a request signal containing the updated priority flag, and transmits the generated request signal to the other device.

28. A data communication response device that receives a data communication request from an other device via a set of channels connecting the data communication response device and the other device, which are capable of performing full-duplex communication and half-duplex communication, comprising:
an initialization unit operable to enable the data communication response device and the other device to share selection information at initialization where full-duplex communication is established, the selection information helping each device to select either full-duplex communication or half-duplex communication in compliance with a procedure predetermined between the devices;
a communication response unit operable to receive, from the other device, a request signal containing a first communication flag, generate a response flag containing a second communication flag, and transmit the generated response signal to the other device via the set of channels, the first communication flag indicating whether half-duplex communication is to be specified in accordance with a capability of the other device, the second communication flag indicating whether half-duplex communication is to be specified in accordance with a capability of the data communication response device;
a selection unit operable to select either a full-duplex communication scheme or a half-duplex communication scheme depending on the first communication flag, the second communication flag, and the selection information in compliance with the procedure; and
a communication unit operable to perform data communication in the selected communication scheme.

29. The data communication response device of claim 28, wherein
the selection information has a priority flag,
the initialization unit receives the priority flag and stores the received priority flag in a predetermined storage area, the priority flag indicating that a communication flag specified by one of the devices having the capability inferior to the other is to take priority,
the procedure includes the steps of
judging whether an indication of the first communication flag accords with an indication of the second communication flag, and
when judging affirmatively, selecting a communication scheme in accordance with the indication, and
when judging negatively, selecting a communication scheme indicated by the communication flag generated by one of the devices which is to take priority depending on the priority flag stored in the predetermined storage area.

30. The data communication response device of claim 29, wherein
in the data communication, data transmission and reception is performed for a plurality of times via the set of channels,
each time data is transmitted and received, a request signal is transmitted from the other device,
prior to commencement of the data communication, the communication response unit receives information with respect to the capability of the other device and stores the received information, and
in generating a response signal in response to a request signal with respect to data transmission and reception for a second time or later on, the communication response unit compares a current capability of the data communication response device with the capability of the other device, updates the priority flag stored in the predetermined storage area according to a comparison result of the communication response unit, generates a response signal containing the updated priority flag, and transmits the generated response signal to the other device.

31. The data communication response device of claim 28, wherein
the set of channels comprises two serial channels,
the other device includes at least two terminals of first and second terminals used for data communication,
the data communication response device comprises a memory card or an I/O card that includes at least two terminals of third and fourth terminals used for data communication,
the data communication response device is removable from the other device, and
when the data communication response device is attached to the other device, two serial channels are formed in such a way that the first and third terminals are connected and that the second and fourth terminals are connected respectively.

32. A communication method used in a data communication system, the data communication system including first and second devices that are capable of performing full-duplex communication and half-duplex communication via a set of channels connecting the first and second devices, wherein
full-duplex communication is established at initialization,
the devices each perform initialization processing of communication, which enables each other to share selection information at initialization where full-duplex communication is established, the selection information helping each device to select either full-duplex communication or half-duplex communication in compliance with a procedure predetermined between the devices,
the first device includes the steps of
generating a request signal containing a first communication flag, and transmitting the generated request signal to the second device via the set of channels, the first communication flag indicating whether half-duplex communication is to be specified in accordance with a capability of the first device,
receiving, from the second device, a response signal containing a second communication flag in response to the request signal, and selecting either the full-duplex communication scheme or the half-duplex communication scheme depending on the first communication flag, the second communication flag, and the selection information in compliance with the procedure, the second communication flag indicating whether half-duplex communication is to be specified in accordance with a capability of the second device, the selected communication scheme conforming to the capability of each device, and
performing data communication in the selected communication scheme, and
the second device includes the steps of
generating the response signal containing the second communication flag in response to the received request signal, and transmitting the generated response signal to the first device via the set of channels,
selecting either the full-duplex communication scheme or the half-duplex communication scheme depending on the first communication flag, the second communication flag, and the selection information in compliance with the procedure, the selected communication scheme conforming to the capability of each device, and
performing data communication in the selected communication scheme.
